(19) United States
(12) Patent Application Publication
(10) Pub. No.: US 2022/0316140 A1
(43) Pub. Date: Oct. 6, 2022

(54) MICROFIBRILLATED COATING COMPOSITIONS, PROCESSES AND APPLICATORS THEREFOR

(71) Applicant: FIBERLEAN TECHNOLOGIES LIMITED, PAR (GB)

(72) Inventors: Per SVENDING, Kungalv (SE); Jonathan PHIPPS, Cornwall (GB); Mark PARADIS, Par Cornwall (GB); Soultana SELINA, Cornwall (GB); David R. SKUSE, Truro (GB)

(73) Assignee: FIBERLEAN TECHNOLOGIES LIMITED, PAR (GB)

(21) Appl. No.: 17/691,700

(22) Filed: Mar. 10, 2022

Related U.S. Application Data
(63) Continuation of application No. PCT/US2022/019683, filed on Mar. 10, 2022.
(60) Provisional application No. 63/170,195, filed on Apr. 2, 2021.

(51) Int. Cl. D21H 19/52; D21H 19/38; D21H 23/24; D21H 23/34; D21H 23/40

(52) U.S. Cl. CPC D21H 19/52; D21H 19/385; D21H 23/24; D21H 23/34; D21H 23/40

(57) ABSTRACT

Methods of making a paper or board product comprising a top ply slurry comprising microfibrillated cellulose and, optionally, one or more inorganic particulate material, applied to a forming web of paper through an applicator comprising a channel terminating in a slot, wherein the slot is in fluid communication with a flexible blade suitable to form a top ply on top of the forming web of paper at the wet end of the paper machine and applicators for practicing such methods.

### FIELD OF INVENTION

The present invention is directed to paper or paperboard products, comprising a substrate or base paper or paperboard and at least one top ply comprising microfibrillated cellulose, optionally in combination with one or more inorganic particulate material, in an amount that is suitable for imparting improved optical, surface, barrier and/or mechanical properties to such paper or paperboard products to render them suitable for printing and/or other end-use demands; to methods of making paper or paperboard products comprising at least one top ply comprising microfibrillated cellulose, optionally in combination with one or more inorganic particulate material, by a process of applying said microfibrillated cellulose, optionally with one or more inorganic particulate material, onto the wet substrate or forming web of paper on the wire at the wet end of a papermaking machine; to improved applicators suitable for applying said at least one top ply to said wet substrate or forming web of paper; and to associated uses of such paper or paperboard products.

### BACKGROUND OF THE INVENTION

Paper and paperboard products are many and various in construction. There is an ongoing need to make quality improvements in paper and paperboard products having optical, surface and/or mechanical properties, which render them suitable for printing and other end-use demands, and to improve the methods for making such paper and paperboard products having improved printability and surface properties, e.g., by reducing cost, making the process more energy efficient and environmentally friendly, and/or improving recyclability of the paper product.

White top linerboard is conventionally made on a multiformer paper machine. The top layer of a white top linerboard frequently comprises a lightly refined bleached hardwood Kraft (short) fibre, which may contain filler in an amount up to about 40 wt. %. The top layer is conventionally applied to cover the base with a layer to improve the optical appearance of the linerboard and to achieve a surface of high brightness suitable for printing or as a base for coating. A pulp-based layer is conventionally used because the base layer normally comprises either unbleached Kraft pulp or recycled paperboard (“OCC,” old corrugated containers), and is thus very rough and unsuitable for coating with conventional equipment. White top linerboards are most often printed flexographically, although some offset printing is used, and inkjet techniques are growing in significance.

With the decline in traditional printing and writing grades, many mills have been looking to convert their graphic paper machines to make linerboard or other packaging products. Conversion of a single layer machine to a multiformer requires a major rebuild and investment, and without this the machine would be limited to making simple linerboard grades. Application of a suitable coating composite to produce a white top linerboard product through a suitable coating apparatus operating at the wet end of the paper machine would provide simple and low cost possibility for the machine to produce economically white top linerboard products. Accordingly, there is a demand for improved, low-cost white top liners.

Applying a low solids content slurry of microfibrillated cellulose and inorganic particulate material to the surface of a linerboard substrate at this point in the linerboard production process would allow the white top linerboard to be drained using existing drainage elements and the resulting white top linerboard to be pressed and dried as a conventional sheet.

Coating onto a wet, freshly-formed substrate presents challenges. Among these challenges is the fact that the surface of a wet substrate will be much rougher than a pressed and dried sheet. For this reason, the top ply slurry of the composite of microfibrillated cellulose and inorganic particulate material must create a uniform flow or curtain of the microfibrillated cellulose or a composite of microfibrillated cellulose and one or more inorganic particulate material, at a suitable flowrate. Moreover, the top ply slurry must be introduced onto the wet web evenly to obtain a contour coat. Once pressed and dried, the top ply must present a surface which is suitable either for printing directly or for single coating. Low porosity and good surface strength are therefore very important properties for the finished white top linerboard.

U.S. Pat. No. 10,214,859 describes application of MFC and mineral compositions to a paper substrate through a non-pressurized or pressurized slot applicator having an opening positioned on top of a wet substrate on the wire of the wet end of a paper machine. Examples of known applicators which may be employed include, without limitation, slot die applicators (including, e.g. non-contact metering slot die applicators jet coaters, liquid application systems, headbox, secondary headbox, curtain coaters, spray coaters and extrusion coaters.

U.S. Pat. No. 10,550,520 describes an applicator for MFC coating onto a wet papermachine web in which the suspension is forced through a narrow slot in order to match the speed of the suspension with the moving paper web upon contact, to avoid elongational break-up of the coating and to minimize the jet velocity perpendicular to the web and prevent its disruption. Using this approach, acceptable formation may be achieved, but only within a narrow range of solids content and slot thickness.

At higher solids contents outside of this range, the rapid recovery of viscosity of the MFC suspension after it leaves the slot and is no longer subject to shear prevents it from flowing over any unevenness or inhomogeneity in the wet paper surface after contact and achieving good formation. Under the high shear conditions in the applicator slot and in the approach flow to it, the MFC suspension shear thins to a low viscosity, and flocs and entanglements are dissipated. Upon exiting the applicator slot, a smooth and stable curtain is formed from the suspension, but this curtain immediately begins to destabilize and eventually breaks up as the viscosity of the suspension builds and flocs and entanglements form, thus preventing good coating formation from being achieved. Good formation of the MFC-based layer is also hard to achieve on rough base papers made from a large proportion of long fibers, as is the case for linerboards made from virgin Kraft and higher quality recycled pulps. Therefore, even if the elongational break-up of the suspension is prevented by matching the speed of the suspension to the moving paper web, poor formation can still occur if the solids content of the suspension is sufficiently high to form rapid entanglements and to prevent flow over the surface after contact, particularly if the surface is rough.

It would clearly be beneficial, therefore, to position the exit of the slot as close to the web as possible in order to minimize the time available for the suspension to regain its viscosity before contacting the paper web. However, if the applicator is brought too close to the web, catastrophic contact between the moving wire and the applicator becomes likely, and debris can accumulate on the applicator from the moving web and subsequently drop off and damage the coating. Furthermore, if the gap between the applicator and web is too small, it has been observed that air entrained under the applicator by the moving web can create irregular pressure pulses which disrupt the curtain and cause major defects in the coating. Conversely, if the applicator is kept at a safe distance from the web, the jet must be aligned away from the horizontal direction and towards the web in order that the distance travelled by the jet be short enough that the jet should remain stable. A solution which maintains shear on the suspension until it contacts the moving web, aligns it parallel with the web at the contact point and yet still allows the applicator to be kept at a suitable distance from the paper web is thus required.

### SUMMARY OF THE INVENTION

The present invention is directed towards processes of making two-layer paper sheets on a paper machine equipped only with a single forming section, by coating a layer of microfibrillated cellulose (MFC) or a mixture of MFC and one or more inorganic particulate material particles on top of the semi-dry paper web in the forming section, or in other words, at the wet end, of a papermaking machine. The present invention also is directed to improved applicators for applying a top ply comprising MFC or comprising a composite of MFC and one or more inorganic particulate material particles in said processes.

Microfibrillated cellulose and pulp suspensions need to be very dilute in order to flow as liquids, and therefore can only economically be formed into sheets or coatings using dewatering by filtration, as is practiced on a paper machine. To make two-layer paperboard products conventionally using pulp fibers, each layer is made in a separate forming section, and the layers are then brought together and pressed in order to form the final product.

U.S. Pat. No. 10,214,859, which is incorporated herein by reference in its entirety, teaches the formation of a two-layer product by application of a coating of MFC and inorganic particulate material on top of an unconsolidated, freshly formed paper web in the forming section of a paper machine. This can be done with MFC as the binder for the ply because, unlike conventional coating binders such as latex or starch, it can be applied directly onto a poorly consolidated paper web and will not significantly penetrate into the structure of the web.

Conventional pulp fibers can also be applied directly onto a poorly consolidated web using a secondary headbox, and will form a separate layer on top of the web. However, very dilute suspensions of fibers are required in order to achieve acceptable formation, and thus only small layer thicknesses can be achieved in this way which are limited by the drainage capacity of the machine. With such a dilute suspension, a large proportion of the fine particles are washed into the base sheet. Furthermore, the network strength of sheets made from conventional pulp fibers limits the amount of mineral that can be incorporated into such a layer to less than 40%, and the resultant layer will be relatively rough and porous compared with a layer made from MFC and, optionally, MFC and one or more inorganic particulate material particles, where the inorganic particulate material content can be as high as 85% whilst still forming a layer with sufficient strength for printing and handling in the final application of the board.

It is critical to achieve good formation of the top layer, either for optical and printing properties, or for impermeability and smoothness if the MFC layer is to be used as a barrier layer or a substrate for the application of a barrier coating. MFC can be applied at much higher solids content and coat weight than conventional pulp fibers and still achieve acceptable formation—the solids content of the MFC suspension should be as high as possible in order both to minimize the amount of water to be removed in the vacuum and press sections of the paper machine and to minimize the amount of inorganic particulate material or fine material that penetrates into the sheet before sufficient layer thickness is achieved to trap it in the upper layer by filtration. However, even with MFC rather than pulp as the binder, high solids can lead to poor layer formation for a number of reasons.

Problems of this type include the formation of aggregates of fibrils (‘flocs’), which are increasingly formed at higher solids, as the fibrils are forced to overlap with each other and become entangled. Although flocs of fibrils become disentangled at high shear, leading to a large reduction in viscosity, the recovery of viscosity of MFC suspensions by re-entanglement of the fibers is a very rapid process, and more significant at higher solids contents.

Another notable problem is that MFC suspensions show low elongational strength, leading to the break-up of a wet film of MFC upon contact with a paper web unless the film is moving at substantially the same speed or higher than the web.

According to the invention, a flexible sheet or ‘blade’ is attached to the upper surface of the slot of the applicator at one end, and the slurry contacts the moving paper web at the other, thus bridging the gap between the slot exit and the web as depicted in FIGS. 1A and 1B Error! Reference source not found. As noted in FIG. 1A, the flexible blade (1a) may extend to and rest on the forming web of paper (2a) at the wet end of paper machine, or, alternatively, the flexible blade (lb) may stop just short of the moving (forming) web of paper (2b) as depicted in FIG. 1B. The coating suspension remains in contact with the blade all the way to the paper surface. Because the surface of the blade forms a stationary boundary on the upper side of the jet of the slurry, the slurry remains under shear until it contacts the surface of the forming web of paper, and also shortly afterwards in the area of contact between the blade and the surface of the forming web of paper. The blade also guides the suspension towards the surface so that it is parallel with it at the point of contact, thus allowing the applicator to be inclined at a non-horizontal angle and sufficiently distanced from the web.

As noted above, FIG. 1A, the flexible blade (1a) may extend to and rest on the forming web of paper (2a) at the wet end of paper machine, or, alternatively, the flexible blade (lb) may stop just short of the moving (forming) web of paper (2b) as depicted in FIG. 1B. The flexible blade operates to guide the top ply slurry (3a) in FIG. 1A from the slot (4a) of any generic applicator (5a) having a slot opening to the forming web of paper (2a). As shown in FIG. 1A the flexible blade (1a) is mounted in a flexible blade holder (6a) at a controlled angle (7) mounted above slot (4) of generic slot applicator (5a).

As noted in FIG. 1B, the flexible blade (lb) may stop just short of the moving (forming) web of paper (2b) as depicted in FIG. 1B. The flexible blade (lb) operates to guide the top ply slurry (3b) in FIG. 1A from the slot (4) of any generic applicator (5b) having a slot opening to the forming web of paper (2b). As shown in FIG. 1B the flexible blade (lb) is mounted in a flexible blade holder (6b) at a controlled angle (7) mounted above slot (4) of generic slot applicator (5b).

Also, to be note in FIGS. 1A and 1B, the channel (8a) and (8b) and slot (4a) and (4b), respectively, of a generic slot applicator (5a/5b) is adjustably positioned so that the slurry (3a/3b) forms an angle (7a/7b) of about 10° to about 45° relative to the forming web of paper (2a/2b). The angle of the slurry emanating from the slot of a generic slot applicator can be set at a controlled angle (7a/7b) by adjusting the angle of the applicator and slot through an adjustable mounting of the applicator (152), as shown in FIG. 12.

In additional embodiments, the controlled angle (7a/7b) shown in FIGS. 1A and 1B may be finely adjusted through the operation of an adjustable mounting block holder (50 in FIG. 8A; and 120 in FIG. 8B) for the flexible blade (35) shown in FIG. 8a and the flexible blade (105) shown in FIG. 8B. The fine adjustment in these figures also enables the length of the flexible blade (35 and 105, respectively) to be adjusted, as shown in FIGS. 8A and 8B. See FIGS. 8A and 8B infra for a more complete description of flexible blade holders (50) and (120), respectively.

The invention described herein is not limited to specific applicators, but comprises an improvement to generic slot applicators that enables the slurry to be delivered from the slot at a controlled angle relative to the forming web of paper, while being guided from the slot to the forming web of paper along the underside of the flexible blade. The foregoing features are more fully described below with reference to specific Figures.

Another function of the flexible blade is to smooth any variations in the profile of the jet or the height of the base, thus further ensuring a coating of uniform thickness. Furthermore, because the flexible blade maintains the suspension under shear until the point of contact with the forming web of paper, thus minimizing its viscosity, it also reduces the need for the suspension to be travelling at a similar velocity to the paper web in order to ensure acceptable formation.

Alternatively, according to the invention, a flexible sheet or ‘blade’ is attached to the upper surface of the slot of the applicator and supports the slurry until it contacts the moving paper web, thus bridging the gap between the slot exit and the web as depicted in FIG. 1B. The coating suspension remains in contact with the blade most of the way to the paper surface. Because the surface of the blade forms a stationary boundary on the upper side of the jet of the slurry, the slurry remains under shear until it contacts the surface of the forming web of paper.

Adjustments described below with reference to the blade holder and flexible blade enable the length of the blade to shortened or lengthened, which allows the delivery of the slurry to forming web of paper to be controlled in a manner which permits delivery of a smooth uninterrupted top ply to the forming web of paper. Since the flexible blade may lightly touch the forming web of paper separated only by the top ply slurry, the flexible blade may be used to provide a smoothing action relative to the supplication of the top ply across the entire width of the slot.

The design and function of the flexible blade affixed to and made a part of the applicator is in marked contrast to that of conventional blades used in applying coatings onto a dry sheet. A conventional blade is made of a stiff material, and removes excess coating formulation from the surface. In a conventional coater, whether of the short-dwell or jet coater type, excess coating is applied to the surface and then removed by the blade, collected and recirculated. Coat weight and uniformity can be controlled by the pressure applied to the blade. Because the paper substrate has been consolidated and dried and has significant strength, substantial pressure may be applied to the flexible blade without risk of tearing or damaging the paper. Substantial pressure cannot be applied to an unconsolidated, wet sheet in the same way, and neither can excess coating be removed at the point of application on a horizontal moving web. Therefore the flexible blade of the current invention must be sufficiently flexible not to damage the web or doctor off any coating, whilst also having sufficient stiffness to resist being lifted by the flow of air drawn by the paper web, and to provide a smoothing effect on the base paper and in certain embodiments when the blade is long enough to contact the web to provide a smoothing effect.

According to a first aspect of the present invention, there is a method of making a paper or board product comprising a top ply comprising microfibrillated cellulose and, optionally, one or more inorganic particulate material, the method comprising: (a) providing a forming web of paper at the wet end of a paper machine; (b) providing a top ply slurry of microfibrillated cellulose of about 0.25 to about 5 wt. % of the total solids content of the slurry, and, optionally one or more inorganic particulate material, onto the forming web of paper through an applicator comprising a channel terminating in a slot, wherein the slot is in fluid communication with a flexible blade attached to the applicator so as to deliver the top ply at a controlled angle to the forming web of paper at the wet end of the paper machine; wherein the forming web of paper and top ply are dewatered and pressed and a paper or board is recovered comprising said top ply; wherein the slurry remains in contact with the flexible blade until the slurry contacts the forming web of paper.

According to a second aspect there is provided an applicator for delivery of a top ply slurry of microfibrillated cellulose, and, optionally, one or more inorganic particulate material, to a forming web of paper at the wet end of a paper machine, comprising an applicator comprising a fluid delivery channel terminating in a slot comprising an upper and lower surface, for applying the top ply slurry to the forming web of paper; a flexible blade attached to the upper surface of the slot, wherein said flexible blade guides delivery of the top ply slurry from the slot to the forming web of paper at the wet end of the papermaking machine at a controlled angle relative to the forming web of paper.

It should be understood that, in general, where the invention, or aspects of the invention, is/are referred to as comprising particular elements, features, etc., certain embodiments of the invention or aspects of the invention comprise, consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The invention includes embodiments in which exactly one member of the group is present in, employed in, or otherwise relevant to a given product or process. The invention also includes embodiments in which more than one, or the entire group members are present in, employed in, or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. Where elements are presented as lists, (e.g., in Markush group or similar format) it is to be understood that each subgroup of the elements is also disclosed, and any element(s) can be removed from the group. The present invention will herein be described in terms of aspects of the invention and certain embodiments of the invention. Certain described embodiments of the invention can be combined into an aspect of the invention and are not meant to be limited only to the recited features identified in certain embodiments.

In an embodiment of the first aspect and the second aspect of the present invention, the controlled angle is about 10°, or is about 15°, or is about 20°, or is about 25°, or is about 30°, or is about 35°, or is about 40°, or is about 45° relative to the forming web of paper, or is about or is about 15° to about 35°, or is about 20° to about 40° relative to the forming web of paper, i.e. a controlled angle of the flexible blade when point down from the slot to the forming web of paper below at the wet end of the paper machine.

In certain embodiments of the first aspect and the second aspect of the present invention, the method further comprises one or more inorganic particulate material, which may be an optional feature of a claim.

In certain embodiments of the first aspect or the second aspect of the present invention, the one or more inorganic particulate material is selected from the group consisting of: calcium carbonate, magnesium carbonate, dolomite, gypsum, an anhydrous kandite clay, kaolin, perlite, diatomaceous earth, wollastonite, talc, magnesium hydroxide, titanium dioxide, or aluminium trihydrate, or combinations thereof.

In other embodiments of the first aspect and the second aspect, the one or more inorganic particulate material may, for example, be an alkaline earth metal carbonate or sulphate, such as calcium carbonate, magnesium carbonate, dolomite, gypsum, a hydrous kandite clay such as kaolin, halloysite or ball clay, an anhydrous (calcined) kandite clay such as metakaolin or fully calcined kaolin, talc, mica, huntite, hydromagnesite, ground glass, perlite or diatomaceous earth, or wollastonite, or titanium dioxide, or magnesium hydroxide, or aluminium trihydrate, lime, graphite, or combinations thereof.

In still other embodiments of the first aspect and the second aspect, the inorganic particulate material comprises or is calcium carbonate, magnesium carbonate, dolomite, gypsum, an anhydrous kandite clay, perlite, diatomaceous earth, wollastonite, magnesium hydroxide, or aluminium trihydrate, titanium dioxide or combinations thereof.

In additional embodiments of the first aspect and the second aspect, the inorganic particulate material is selected from the group consisting of the an alkaline earth metal carbonate or sulphate, calcium carbonate, magnesium carbonate, dolomite, gypsum, bentonite, montmorillonite, hydrous kandite clay, kaolin, halloysite or ball clay, an anhydrous (calcined) kandite clay; as metakaolin or fully calcined kaolin, talc, mica, perlite sepiolite, huntite, diatomite, magnesite, silicates, or diatomaceous earth, brucite, aluminum trihydrate, and combinations thereof.

In certain still further of the first aspect and the second aspect, the inorganic particulate material is selected from the group consisting of the an alkaline earth metal carbonate or sulphate, calcium carbonate, magnesium carbonate, dolomite, gypsum, bentonite, a hydrous kandite clay, kaolin, halloysite or ball clay, an anhydrous (calcined) kandite clay, as metakaolin or fully calcined kaolin, talc, mica, perlite sepiolite, huntite, diatomite, magnesite, silicates, or diatomaceous earth, brucite, aluminum trihydrate, and combinations thereof.

In certain embodiments of the first aspect and the second aspect, the forming web of paper comprises a chemical pulp, or a chemi-thermomechanical pulp, or a mechanical pulp, unbleached Kraft pulp or a recycled pulp, or a papermill broke, or a papermill waste stream, or waste from a papermill, or a dissolving pulp, kenaf pulp, market pulp, partially carboxymethylated pulp, abaca pulp, hemlock pulp, birch pulp, grass pulp, bamboo pulp, palm pulp, peanut shell, or a combination thereof.

In other embodiments of the first aspect and the second aspect, the forming web of paper comprises a unbleached Kraft pulp, recycled pulp or a combination thereof.

In additional embodiments of the first aspect and the second aspect, the microfibrillated cellulose is manufactured from a chemical pulp, or a chemi-thermomechanical pulp, or a mechanical pulp, unbleached Kraft pulp or a recycled pulp, or a papermill broke, or a papermill waste stream, or waste from a papermill, or a dissolving pulp, kenaf pulp, market pulp, partially carboxymethylated pulp, abaca pulp, hemlock pulp, birch pulp, grass pulp, bamboo pulp, palm pulp, peanut shell, or a combination thereof.

In certain embodiments of the first aspect and the second aspect of the present invention, the slurry is provided at a flowrate of between about 30 and about 500 litres/min/m.

In certain embodiments of the first aspect and the second aspect, the distance of the slot to the forming web of paper is about 50 mm to about 250 mm.

In certain embodiments of the first aspect and the second aspect, the difference between the velocity of the slurry and the velocity of the forming web of paper is in the range of about −150 m/min to +300 m/min.

In certain embodiments of the first aspect and the second aspect, the content of inorganic particulate material is from 0% to 50% by weight of the total solids content of the slurry.

In other embodiments of the first aspect and the second aspect, the content of inorganic particulate materials is from 50% to 70%.

In still other embodiments of the first aspect and second aspect, the content of inorganic particulate material is from 5% to 50%, 10% to 40%, or 20% to 30%

In certain embodiments of the first aspect and the second aspect, the slurry is an aqueous composition.

In certain embodiments of the first aspect and the second aspect, the slot has a vertical gap height of less than 2.5 mm.

In certain embodiments of the first aspect and the second aspect, the liquid composition at the point of impact with the forming web of paper is travelling at about the same speed as or higher than the speed of the forming web of paper.

In certain embodiments of the first aspect and the second aspect, the flexible blade stiffness is between about 2 to about 75 mN m, as measured by a bending stiffness tester, for example, an L & W (AB Lorentzen & Wettre Paper Bending Tester) bending tester used in accordance with DIN 53121, or another equivalent apparatus.

In certain embodiments of the first aspect and the second aspect, the forming web of paper comprises greater than about 50 wt. % of water, based on the total weight of the forming web of paper.

In certain embodiments of the first aspect and the second aspect, the forming web of paper comprises up to about 1 wt. % of retention aid, based on the total weight of the forming web of paper.

In certain embodiments of the first aspect and the second aspect, the board product is a white top linerboard product.

In certain embodiments of the first aspect and the second aspect, the paper or board has a grammage suitable for use in a containerboard product, comprising a grammage ranging from about 50 g/m² to about 500 g/m².

In certain embodiments of the first aspect and the second aspect, the paper or board comprises recycled pulp, unbleached Kraft, or combinations thereof.

In certain embodiments of the first aspect and the second aspect, the inorganic particulate material and the microfibrillated cellulose comprise greater than 95 wt. % of the top ply, based on the total weight of the top ply.

In other embodiments of the first aspect and the second aspect, the top ply comprises at least 70 wt. % of an inorganic particulate material, based on the total weight of the top ply.

In further embodiments of the first aspect and the second aspect, the top ply comprises at least about 80 wt. % of an inorganic particulate material, based on the total weight of the top ply.

In still further embodiments of the first aspect and the second aspect, the inorganic particulate material comprises or is calcium carbonate.

In certain embodiments of the first aspect and the second aspect, the top ply comprises up to about 2 wt. %, in total, of additives selected from the group consisting of flocculant, formation/drainage aid, water soluble thickener, starch, retention aid, hydrophobing (sizing) agents, and combinations thereof.

In certain embodiments of the first aspect and the second aspect, the top ply is devoid of additional organic compound.

In certain embodiments of the first aspect and the second aspect, the top ply is devoid of cationic polymer, anionic polymer, or polysaccharide hydrocolloid, and the top ply is an outer ply.

In certain embodiments of the first aspect and the second aspect, the top ply is devoid of wax, polyolefins, and silicone.

In certain embodiments of the first aspect and the second aspect, the top ply consists essentially of, inorganic particulate and microfibrillated cellulose.

In certain embodiments of the first aspect and the second aspect of the present invention, the delivery of the top ply slurry is at a flowrate of between about 30 and about 500 litres/min/m.

In certain embodiments of the first aspect and second aspect of the present invention, the top ply slurry remains in contact with the flexible blade until the slurry contacts the forming web.

In certain embodiments of the first aspect and the second aspect, the distance of the slot to the forming web of paper is about 50 mm to about 250 mm.

In certain embodiments of the first aspect and the second aspect, the difference between the velocity of the slurry and the velocity of the forming web of paper is in the range of about −150 m/min to +300 m/m.

In certain embodiments of the first aspect and the second aspect, the flexible blade stiffness is between about 2 to about 75 mN m, as measured by a bending stiffness tester, for example, an L&W (AB Lorentzen & Wettre Paper Bending Tester) bending tester used in accordance with DIN 53121, or another equivalent apparatus.

In certain embodiments of the first aspect and the second aspect, the slot has a vertical gap height of less than 2.5 mm.

In certain embodiments of the first aspect and the second aspect, the paperboard products are a white top paperboard or a white top linerboard.

In certain embodiments of the first aspect and the second aspect, the top ply is present in the product in an amount ranging from about 20 g/m² to about 30 g/m², particularly at least about 30 g/m².

In other embodiments of the first aspect and the second aspect, the top ply is present in the product in an amount ranging from about 1 g/m² to about 15 g/m².

In certain embodiments of the first and second aspect, the brightness measured (according to ISO Standard 11475 (F8; D65-400 nm)) on the top ply is increased compared to the brightness measured on the substrate on a surface opposite the top ply.

Advantageously, in certain embodiments the top ply provides good optical and physical coverage over a dark substrate, for example of the first aspect and the second aspect, a substrate of a brightness of 15-25, with the potential to yield an improved brightness of at least about 60%, or at least about 65%, at least about 70%, or at least about 80% at a coating weight of about 30 g/m².

In certain embodiments of the first aspect and the second aspect, the product comprises or is a paperboard product, and in some embodiments the product is a white top paperboard, containerboard or linerboard product. In addition, improvements in brightness can be made utilizing the first and second aspects at coverages of about 30 g/m² to reach brightness levels of 80% or more compared to conventional white top layers typically requiring 50-60 g/m² at lower filler loadings of typically 5-15 wt. %.

In certain embodiments of the first aspect and the second aspect, the weight ratio of inorganic particulate to microfibrillated cellulose in the top ply is from about, 8:1 to about 1:1, or from about 6:1 to about 3:1, or from about 5:1 to about 2:1, or from about 5:1 to about 3:1, or about 4:1 to about 3:1.

In certain embodiments of the first aspect and the second aspect of the present invention, there is provided a method of making a paper or paperboard product, the method comprising: (a) providing a wet web of pulp; (b) providing a top ply slurry onto the wet web of pulp, wherein: (i) the top slurry is provided in an amount ranging from 15 g/m² to 40 g/m² and (ii) the top ply slurry comprises a sufficient amount of microfibrillated cellulose to obtain a product having a top ply comprising at least about 5 wt. % microfibrillated cellulose based on the total weight of top ply; (iii) and the top slurry comprises inorganic particulate material and microfibrillated cellulose. In additional embodiments, the top ply comprises microfibrillated cellulose in an amount of at least about 10 wt. %, at least about 20 wt. %, or up to about 30 wt. %, or up to about 40 wt. %, or up to about 50 wt. %, or up to about 60 wt. %, or up to about 70 wt. % or up to about 80 wt. %, or up to about 90 wt. %, or up to about 100 wt. %, based on the total weight of the top ply.

In other embodiments of the first aspect and the second aspect of the present invention, there is provided a method of making a paper or paperboard product, the method comprising: (a) providing a wet web of pulp; (b) providing a top ply slurry onto the wet web of pulp, wherein the top ply slurry is in an amount sufficient to obtain a product having a top ply comprising from 1 g/m² to 15 g/m² microfibrillated cellulose based on the total weight of top ply; wherein the top ply optionally may further comprise one or more inorganic particulate material and microfibrillated cellulose.

In certain embodiments of the first aspect and the second aspect of the present invention, there is provided a method directed to the use of a top ply comprising at least about 20 wt. % microfibrillated cellulose, based on the total weight of the top ply, as a top layer on a paperboard substrate. In additional embodiments, the present invention is directed to the use of a top ply comprising up to about 30 wt. % microfibrillated cellulose, based on the total weight of the top ply, as a top layer on a paperboard substrate, or a top ply comprising up to about 40 wt. % microfibrillated cellulose, based on the total weight of the top ply, as a top layer on a paperboard substrate, or a top ply comprising up to about 50 wt. % microfibrillated cellulose, based on the total weight of the top ply, as a top layer on a paperboard substrate, or a top ply comprising up to about 60 wt. % microfibrillated cellulose, based on the total weight of the top ply, as a top layer on a paperboard substrate, or a top ply comprising up to about 70 wt. % microfibrillated cellulose, based on the total weight of the top ply, as a top layer on a paperboard substrate, or a top ply comprising up to about 80 wt. % microfibrillated cellulose, based on the total weight of the top ply, as a top layer on a paperboard substrate, or as a top ply comprising up to about 90 wt. % microfibrillated cellulose, based on the total weight of the top ply, as a top layer on a paperboard substrate, or as a top ply comprising up to about 95 wt. % microfibrillated cellulose, based on the total weight of the top ply, as a top layer on a paperboard substrate, or as a top ply comprising up to about 100 wt. % microfibrillated cellulose, based on the total weight of the top ply, as a top layer on a paperboard substrate

In certain of the foregoing embodiments of the first aspect and the second aspect of the present invention, the top ply may optionally contain one or more particulate material.

In certain of the foregoing embodiments of the first aspect and the second aspect of the present invention, the top ply may comprise a barrier layer.

In further embodiments of the first aspect and the second aspect, the top ply may be a precoat for a water-based barrier coating applied conventionally onto the paperboard after drying. In this case its purpose would be to provide a smooth, low porosity surface for the barrier coating, thus increasing the effectiveness of and/or decreasing the grammage required for the latter.

In some additional embodiments of the first aspect and the second aspect of the present invention, the top ply may comprise a white top ply.

In certain embodiments of the first aspect and the second aspect of the present invention there is provided a method directed to forming a curtain or film through a non-pressurized or pressurized slot opening on top of a wet substrate on the wire of the wet end of a paper machine to apply a top ply to a substrate to manufacture a paper or paperboard product of the first and second aspects of the present invention.

In certain additional embodiments of the first aspect and the second aspect, the composite of microfibrillated cellulose and inorganic particulate materials may be applied as a white top layer or other top layer. In other embodiments, the applied ply may serve as a base for later application of a barrier coating. Advantageously, the process may be performed utilizing the applicator with affixed flexible blade of the second aspect to a dry or semi-dry paper or paperboard product. Moreover, the existing drainage elements and press section of a paper machine such as the drainage table of a Fourdrinier machine may be utilized for water removal. The top ply of microfibrillated cellulose and, optionally, one or more inorganic particulate material has the ability to stay on top of the substrate and to provide good optical and physical coverage at a low basis weight of the paper or paperboard product.

### BRIEF DESCRIPTION OF THE DRAWINGS

FIGS. 1A and 1B are diagrams of an applicator with a flexible blade of the present invention. FIG. 1A depicts the flexible blade in contact with the forming web of paper and FIG. 1B depicts the flexible blade that stops short of the forming web of paper at the wet end of the paper machine.

FIG. 2A-C are flatbed transmitted light images of coatings made from formulations at different solids contents applied to a dry basepaper using a slotted applicator without a flexible blade. Coatings were peeled from the basepaper before analysis. FIG. 2A is a coating at 7.7 wt. % total solids applied at 42 grams per square meter (gsm). FIG. 2B is a coating at 10 wt. % total solids applied at 69 gsm. FIG. 2C is a coating at 12 wt. % total solids applied at 80 gsm.

FIG. 3 is a plot of intensity variation of transmitted light from the 3 coatings shown in FIGS. 2A to 2C.

FIG. 4A is a flatbed scan of the appearance of the coating applied without the flexible blade affixed to the applicator. FIG. 4B is a photograph of the appearance of the same coating applied with an applicator affixed with a flexible blade composed of PVC. The coatings were applied at 9.2 wt. % total solids at a velocity of 480 m/min, giving a jet/paper velocity ratio of 1.2 and at a coat weight of 45 gsm with the PVC blade (FIG. 4B) and with none (FIG. 4A). As noted in the Examples, the drum was rotating at a circumferential velocity of 400 m/min. This can be deduced from the jet/paper velocity ratio reported in the Examples.

FIGS. 5A and 5B are magnified scans of the coatings depicted in FIGS. 4A and 4B. Flatbed scans of coated samples with (FIG. 5B) and without (FIG. 5A) blade in reflected light.

FIG. 6 is a plot of intensity variation of reflected light from the coatings shown in FIGS. 4A and B.

FIGS. 7A and 7B show a generic drawing of blade holder with flexible blade attached to the top side of the applicator slot exit.

FIGS. 8A and B show embodiments of an applicator blade holder with flexible blade attached to the top side of the applicator exit. FIG. 8A shows the flexible blade in substantially parallel orientation to the forming web of paper (not shown). FIG. 8B shows the flexible blade in a controlled angular orientation to the forming web of paper (not shown).

FIG. 9 shows an alternative embodiment of a blade holder with flexible blade of adjustable length attached to the top side of the applicator exit.

FIG. 10 shows a portion of an applicator depicting a slot for insertion of a flexible blade with riveted tabs (see FIG. 11).

FIG. 11 shows a flexible blade (251) with riveted tabs (250).

FIG. 12 depicts an alternative embodiment of a generic slot applicator (151) with adjustable slot (153) and flexible blade (155) relative to the forming web of paper (154).

FIG. 13 is a plot of slot widths as a function of changes in basis weight (from 30 g/m²) and J/W ration (from 1) and solids content (from 7%). FIG. 13 presents a graphic representation of relating grammage, solids content and jet/wire ratio for determining slot thickness adjustments.

### DETAILED DESCRIPTION OF THE INVENTION

The titles, headings and subheadings provided herein should not be interpreted as limiting the various aspects of the disclosure. Accordingly, the terms defined below are more fully defined by reference to the specification in its entirety. All references cited herein are incorporated by reference in their entirety.

The foregoing has outlined rather broadly the features and technical advantages of the first and second aspects of the present invention in order that the detailed description of the invention that follows may be better understood. Additional features and advantages of the invention will be described herein, which may form the subject of the claims of the invention. It should be appreciated by those skilled in the art that any conception and specific embodiment disclosed herein may be readily utilized as a basis for modifying or designing other means for carrying out the same purposes of the present invention. It should also be realized by those skilled in the art that such equivalent means do not depart from the spirit and scope of the invention as set forth in the appended claims. The novel features which are believed to be characteristic of the invention, both as to its organization and method of operation, together with further objects and advantages will be better understood from the following description when considered in connection with the accompanying Figures. It is to be expressly understood, however, that any description, Figure, Example, etc. is provided for the purpose of illustration and description only and is by no means intended to define the limits the invention.

Unless otherwise defined, scientific and technical terms used herein shall have the meanings that are commonly understood by those of ordinary skill in the art. Further, unless otherwise required by context, singular terms shall include pluralities and plural terms shall include the singular.

In this application, the use of “or” means “and/or” unless stated otherwise. In the context of a multiple dependent claim, the use of “or” refers back to more than one preceding independent or dependent claim in the alternative only.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z.

The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the terms “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, unrecited elements or method steps. Additionally, a term that is used in conjunction with the term “comprising” is also understood to be able to be used in conjunction with the term “consisting of” or “consisting essentially of.”

As used herein, the term “include” and its grammatical variants are intended to be non-limiting, such that recitation of items in a list is not to the exclusion of other like items that can be substituted or added to the listed items.

The fibrous substrate comprising cellulose (variously referred to herein as “fibrous substrate comprising cellulose,” “cellulose fibers,” “fibrous cellulose feedstock,” “cellulose feedstock” and “cellulose-containing fibers (or fibrous,” etc.) may be derived from virgin or recycled pulp or a papermill broke and/or industrial waste, or a paper streams rich in mineral fillers and cellulosic materials from a papermill.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time.

As used herein, the phrase “integer from X to Y” means any integer that includes the endpoints. For example, the phrase “integer from 1 to 5” means 1, 2, 3, 4, or 5.

It has surprisingly been found that a ply comprising microfibrillated cellulose and, optionally, a composite of one or more inorganic particulate material and microfibrillated cellulose, can be added onto a paper web in the wet-end of a paper machine (such as a Fourdrinier machine), immediately after the wet line forms and, where the web is still less than 10-15 wt. % solids. The top ply may be applied according to the method of the first aspect and using the applicator with affixed flexible blade of the second aspect of the present invention. The top ply paper or paper board made by the disclosed process provides advantageous optical properties (e.g., brightness) as well as light-weighting and/or surface improvement (e.g., smoothness and low porosity, while maintaining suitable mechanical properties (e.g., strength for end-use applications). In addition, barrier layers of microfibrillated cellulose applied in accordance with the method of the first aspect and/or utilizing the improved applicators of the second aspect can confer beneficial properties to the paper or board substrate upon which the barrier layer is applied. These improved properties include improved oil and grease resistance, and reduced oxygen or oil vapor permeability as well as improved optical, surface, barrier and/or mechanical properties, including, for example, improved porosity, smoothness and coating. The improved properties may also be realized when the ply applied to the wet substrate serves as a base or precoat for a later-applied barrier coating.

By “top” ply is meant that a top ply is applied on or to the substrate, which substrate may have intermediary plies or layers below the top ply. In certain embodiments, the top ply is an outer ply, i.e., does not have another ply atop. In certain embodiments, the top ply has a grammage of at least about 15 g/m² to about 40 g/m. In other embodiments for barrier coatings, the top ply has a grammage of at least about 1 g/m² to about 15 g/m². In some embodiments, the ply of microfibrillated cellulose and, optionally a composite of microfibrillated cellulose and one or more inorganic particulate material, may in certain embodiments serve as a base or precoat for later application of one or more additional barrier layers as top layers.

Unless otherwise stated, amounts are based on the total dry weight of the top ply and/or substrate.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₀ is the value determined in this way of the particle e.s.d at which there are 50% by weight of the particles which have an equivalent spherical diameter less than that d₅₀ value.

Alternatively, where stated, the particle size properties referred to herein for the inorganic particulate materials are as measured by the well-known conventional method employed in the art of laser light scattering, using a Malvern Mastersizer 3000 or Malvern Insitec, as supplied by Malvern Instruments Ltd (or equivalent laser light scattering device or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the ‘equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value.

Unless otherwise stated, particle size properties of the microfibrillated cellulose materials are as measured by the well-known conventional method employed in the art of laser light scattering, using a Malvern Insitec machine as supplied by Malvern Instruments Ltd (or by other methods which give essentially the same result).

Details of the procedure used to characterize the particle size distributions of mixtures of inorganic particle material and microfibrillated cellulose using a Malvern Insitec machine are provided below.

Top Ply

In certain embodiments of the first and second aspects, the top ply comprises at least about 1 wt. % microfibrillated cellulose, based on the total weight of the top ply. In certain embodiments, the top ply comprises from about 1 wt. % to about 15 wt. % microfibrillated cellulose, or about 5 wt. % to about 25 wt. %, or from about 10 wt. % to about 30 wt. %, or from about 15 wt. % to about 25 wt. %, or from about 17.5 wt. % to about 22.5 wt. %, or about 20 wt. %, based on the total weight of the top ply.

In other embodiments of the first and second aspect of the present invention, the top ply comprises at least about 5 wt. % microfibrillated cellulose, based on the total weight of the top ply, or the top ply comprises at least about 10 wt. % microfibrillated cellulose, based on the total weight of the top ply, or the top ply comprises at least about 15 wt. % microfibrillated cellulose, based on the total weight of the top ply, or the top ply comprises at least about 20 wt. % microfibrillated cellulose, based on the total weight of the top ply, or the top ply comprises at least about 25 wt. % microfibrillated cellulose, based on the total weight of the top ply, or the top ply comprises at least about 30 wt. % microfibrillated cellulose, based on the total weight of the top ply, or the top ply comprises at least about 35 wt. % microfibrillated cellulose, based on the total weight of the top ply, or the top ply comprises at least about 40 wt. % microfibrillated cellulose, based on the total weight of the top ply, or the top ply comprises at least about 45 wt. microfibrillated cellulose, based on the total weight of the top ply, or the top ply comprises at least about 50 wt. % microfibrillated cellulose, based on the total weight of the top ply, or the top ply comprises at least about 55 wt. % microfibrillated cellulose, based on the total weight of the top ply, or the top ply comprises at least about 60 wt. % microfibrillated cellulose, based on the total weight of the top ply, or the top ply comprises at least about 65 wt. % microfibrillated cellulose, based on the total weight of the top ply, or the top ply comprises at least about 70 wt. % microfibrillated cellulose, based on the total weight of the top ply, or the top ply comprises at least about 75 wt. % microfibrillated cellulose, based on the total weight of the top ply, or the top ply comprises at least about 80 wt. % microfibrillated cellulose, based on the total weight of the top ply, or the top ply comprises at least about 85 wt. % microfibrillated cellulose, based on the total weight of the top ply, or the top ply comprises at least about 90 wt. % microfibrillated cellulose, based on the total weight of the top ply, or the top ply comprises at least about 95 wt. % microfibrillated cellulose, based on the total weight of the top ply, or the top ply comprises at about 100 wt. % microfibrillated cellulose, based on the total weight of the top ply.

In certain embodiments of the first and second aspect, the top ply comprises at least about 67 wt. % inorganic particulate material, or at least about 70 wt. % inorganic particulate material, or at least about 75 wt. % inorganic particulate material, or at least about 80 wt. % inorganic particulate material, or at least about 85 wt. % inorganic particulate material, or at least about 90 wt. % inorganic particulate material, based on the total weight of the top ply.

In certain embodiments of the first aspect and second aspect of the present invention the top ply slurry may contain, optionally, from 0 to 3 wt. % of other additives. In other embodiments of the first aspect and second aspect of the present invention the top ply slurry may contain greater than 3 wt. % of other additives.

In certain embodiments of the first and second aspect, the microfibrillated cellulose and inorganic particulate material provide a top ply grammage of from about 15 g/m² to about 40 g/m². In this and other embodiments, the weight ratio of inorganic particulate to microfibrillated cellulose in the top ply is from about 20:1, or about 10:1, or about 5:1, or about 4:1, or about 3:1 or about 2:1.

In other embodiments of the first and second aspect, the microfibrillated cellulose and inorganic particulate material provide a top ply grammage of from about 1 g/m² to about 15 g/m² in the case of top ply barrier coatings.

In other embodiments of the first and second aspect, the microfibrillated cellulose and inorganic particulate material provide a top ply grammage of at least about 15 g/m² to about 40 g/m.

In certain embodiments of the first and second aspect, the top ply comprises from about 70 wt. % to about 90 wt. % inorganic particulate material and from about 10 wt. % to about 30 wt. % microfibrillated cellulose, based on the total weight of the top ply, and optionally up to 3 wt. % of other additives.

In certain embodiments of the first and second aspect, the top ply is optionally may contain additional organic compound, i.e., organic compound other than microfibrillated cellulose.

In certain embodiments of the first and second aspect, the top ply is optionally may contain cationic polymer, anionic polymer, and/or polysaccharide hydrocolloid.

In certain embodiments of the first and second aspect, the top ply is optionally may contain wax, polyolefins, and/or silicone.

In certain embodiments of the first and second aspect, the top ply is devoid of an optical brightening agent.

In certain embodiments of the first and second aspect, the top ply consists essentially of inorganic particulate material and microfibrillated cellulose, and as such comprises no more than about 3 wt. %, for example, no more than about 2 wt. %, or no more than about 1 wt. %, or no more than about 0.5 wt. % of additives other than inorganic particulate material and microfibrillated cellulose. In such embodiments, the top ply may comprise up to about 3 wt. % of additives selected from flocculant, formation/drainage aid (e.g., poly(diallyldimethylammoniumchloride, Polydadmac), cationic polyacrylamide (Percol® 292), water soluble thickener, starch (e.g., cationic starch), sizing agent, e.g., rosin, alkylketene dimer (“AKD”), alkenylsuccinic anhydride (“ASA”) or similar materials and combinations thereof, for example, up to about 2 wt. % of such additives, or up to about 1 wt. % of such additives, or up to about 0.5 wt. % of such additives.

In certain embodiments of the first and second aspect, we have found that adding small amounts of retention/drainage aids, such as poly(diallyldimethylammoniumchloride, Polydadmac), as opposed to much greater amounts used in normal papermaking, the lowered amount of retention aid provides microscale flocculation with no visible negative impact on formation of the substrate, but results in positive impacts on dewatering. This results in significant improvements in dewatering speed.

In certain embodiments of the first and second aspect, the top ply consists of inorganic particulate material and microfibrillated cellulose, and as such comprises less than about 0.25 wt. %, for example, less than about 0.1 wt. %, or is free of additives other than inorganic particulate material and microfibrillated cellulose, i.e., additives selected from flocculant, formation/drainage aid (e.g., poly(acrylamide-co-diallyldimethylammoniumchloride) solution (Polydadmac)), water soluble thickener, starch (e.g., cationic starch) and combinations thereof.

Microfibrillated Cellulose

The microfibrillated cellulose may be derived from any suitable source.

By “microfibrillated cellulose” is meant a cellulose composition in which microfibrils of cellulose are liberated or partially liberated as individual species or as smaller aggregates as compared to the fibers of a pre-microfibrillated cellulose. The microfibrillated cellulose may be obtained by microfibrillating cellulose, including but not limited to the processes described herein. Typical cellulose fibers (i.e., pre-microfibrillated pulp or pulp not yet fibrillated) suitable for use in papermaking include larger aggregates of hundreds or thousands of individual cellulose microfibrils. By microfibrillating the cellulose, particular characteristics and properties, including but not limited to the characteristics and properties described herein, are imparted to the microfibrillated cellulose and the compositions including the microfibrillated cellulose.

Microfibrillated cellulose (MFC), although well-known and described in the art, for purposes of the presently disclosed and/or claimed inventive concept(s), microfibrillated cellulose is defined as cellulose consisting of microfibrils in the form of either isolated cellulose microfibrils and/or microfibril bundles of cellulose, both of which are derived from a cellulose raw material. Thus, microfibrillated cellulose is to be understood to comprise partly or totally fibrillated cellulose or lignocellulose fibers, which may be achieved by a variety of processes known in the art.

As used herein, “microfibrillated cellulose” can be used interchangeably with “microfibrillar cellulose,” “nanofibrillated cellulose,” “nanofibril cellulose,” “nanofibers of cellulose,” “nanoscale fibrillated cellulose,” “microfibrils of cellulose,” and/or simply as “MFC.” Additionally, as used herein, the terms listed above that are interchangeable with “microfibrillated cellulose” may refer to cellulose that has been completely microfibrillated or cellulose that has been substantially microfibrillated but still contains an amount of non-microfibrillated cellulose at levels that do not interfere with the benefits of the microfibrillated cellulose as described and/or claimed herein

By “microfibrillating” is meant a process in which microfibrils of cellulose are liberated or partially liberated as individual species or as small aggregates as compared to the fibers of the pre-microfibrillated pulp. Typical cellulose fibers (i.e., pre-microfibrillated pulp) suitable for use in papermaking include larger aggregates of hundreds or thousands of individual cellulose fibrils

Microfibrillated cellulose comprises cellulose, which is a naturally occurring polymer comprising repeated glucose units. The term “microfibrillated cellulose”, also denoted MFC, as used in this specification, includes microfibrillated/microfibrillar cellulose and nano-fibrillated/nanofibrillar cellulose (NFC), which materials are also called nanocellulose.

There are numerous methods of preparing microfibrillated cellulose that are known in the art.

In a non-limiting example, the term microfibrillated cellulose is used to describe fibrillated cellulose comprising nanoscale cellulose particle fibers or fibrils frequently having at least one dimension less than 100 nm. When liberated from cellulose fibers, fibrils typically have a diameter less than 100 nm. The actual diameter of cellulose fibrils depends on the source and the method of measuring such fibrils as well as the manufacturing methods that are employed.

The particle size distribution and/or aspect ratio (length/width) of the cellulose microfibrils attached to the fibrillated cellulose fiber or as a liberated microfibril depends on the source and the manufacturing methods employed in the microfibrillation process.

In a non-limiting example, the aspect ratio of microfibrils is typically high and the length of individual microfibrils may be more than one micrometer and the diameter may be within a range of about 5 to 60 nm with a number-average diameter typically less than 20 nm. The diameter of microfibril bundles may be larger than 1 micron.

In a non-limiting example, the smallest fibril is conventionally referred to as an elementary fibril, which generally has a diameter of approximately 2-4 nm. It is also common for elementary fibrils to aggregate, which may also be considered as microfibrils.

In a non-limiting example, the microfibrillated cellulose may at least partially comprise nanocellulose. The nanocellulose may comprise mainly nano-sized fibrils having a diameter that is less than 100 nm and a length that may be in the micron-range or lower. The smallest microfibrils are similar to the so-called elementary fibrils, the diameter of which is typically 2 to 4 nm. Of course, the dimensions and structures of microfibrils and microfibril bundles depend on the raw materials used in addition to the methods of producing the microfibrillated cellulose. Nonetheless, it is expected that a person of ordinary skill in the art would understand the meaning of “microfibrillated cellulose” in the context of the presently disclosed and/or claimed inventive concept(s).

Depending on the source of the cellulose fibers and the manufacturing process employed to microfibrillate the cellulose fibers, the length of the fibrils can vary, frequently from about 1 to greater than 10 micrometers.

A coarse MFC grade might contain a substantial fraction of fibrillated fibers, i.e. protruding fibrils from the tracheid (cellulose fiber), and with a certain amount of fibrils liberated from the tracheid (cellulose fiber).

In an embodiment of the first and second aspect, the microfibrillated cellulose may also be prepared from recycled pulp or a papermill broke and/or industrial waste, or a paper streams rich in mineral fillers and cellulosic materials from a papermill.

The fibrous substrate comprising cellulose may be added to a grinding vessel in a dry state. For example, a dry paper broke may be added directly to the grinder vessel. The aqueous environment in the grinder vessel will then facilitate the formation of a pulp.

In certain embodiments, the microfibrillated cellulose has a d₅₀ ranging from about 5 μm to about 500 μm, as measured by laser light scattering. In certain embodiments, the microfibrillated cellulose has a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

In certain embodiments of the first and second aspect, the microfibrillated cellulose has a modal fibre particle size ranging from about 0.1-500 μm. In certain embodiments, the microfibrillated cellulose has a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm. Additionally or alternatively, the microfibrillated cellulose may have a fibre steepness equal to or greater than about 10, as measured by Malvern. Fibre steepness (i.e., the steepness of the particle size distribution of the fibers) is determined by the following formula, where “d” expresses the median diameter, as measured by Malvern:

Steepness=100×(d₃₀/d₇₀)

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40.

Inorganic Particulate Material

The inorganic particulate material may, for example, be an alkaline earth metal carbonate or sulphate, such as calcium carbonate, magnesium carbonate, dolomite, gypsum, a hydrous kandite clay such as kaolin, halloysite or ball clay, an anhydrous (calcined) kandite clay such as metakaolin or fully calcined kaolin, talc, mica, huntite, hydromagnesite, ground glass, perlite or diatomaceous earth, or wollastonite, or titanium dioxide, or magnesium hydroxide, or aluminium trihydrate, lime, graphite, or combinations thereof.

In certain embodiments of the first and second aspect, the inorganic particulate material comprises or is calcium carbonate, magnesium carbonate, dolomite, gypsum, an anhydrous kandite clay, perlite, diatomaceous earth, wollastonite, magnesium hydroxide, or aluminium trihydrate, titanium dioxide or combinations thereof.

In certain embodiments of the first and second aspect, the inorganic particulate material is selected from the group consisting of the an alkaline earth metal carbonate or sulphate, calcium carbonate, magnesium carbonate, dolomite, gypsum, bentonite, a hydrous kandite clay, kaolin, halloysite or ball clay, an anhydrous (calcined) kandite clay, as metakaolin or fully calcined kaolin, talc, mica, perlite sepiolite, huntite, diatomite, magnesite, silicates, or diatomaceous earth, brucite, aluminum trihydrate, and combinations thereof.

In certain embodiments of the first and second aspect, the inorganic particulate material is selected from the group consisting of the an alkaline earth metal carbonate or sulphate, calcium carbonate, magnesium carbonate, dolomite, gypsum, bentonite, a hydrous kandite clay, kaolin, halloysite or ball clay, an anhydrous (calcined) kandite clay, as metakaolin or fully calcined kaolin, talc, mica, perlite sepiolite, huntite, diatomite, magnesite, silicates, or diatomaceous earth, brucite, aluminum trihydrate, and combinations thereof.

An exemplary inorganic particulate material for use in the present invention is calcium carbonate. Hereafter, the invention may tend to be discussed in terms of calcium carbonate, and in relation to aspects where the calcium carbonate is processed and/or treated. The invention should not be construed as being limited to such embodiments.

The particulate calcium carbonate used in the present invention may be obtained from a natural source by grinding. Ground calcium carbonate (GCC) is typically obtained by crushing and then grinding a mineral source such as chalk, marble or limestone, which may be followed by a particle size classification step, in order to obtain a product having the desired degree of fineness. Other techniques such as bleaching, flotation and magnetic separation may also be used to obtain a product having the desired degree of fineness and/or colour. The particulate solid material may be ground autogenously, i.e. by attrition between the particles of the solid material themselves, or, alternatively, in the presence of a particulate grinding medium comprising particles of a different material from the calcium carbonate to be ground. These processes may be carried out with or without the presence of a dispersant and biocides, which may be added at any stage of the process.

Precipitated calcium carbonate (PCC) may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, a calcium carbonate feed material, such as limestone, is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide may be substantially completely separated from the calcium carbonate if this process is used commercially. In the third main commercial process the milk of lime is first contacted with ammonium chloride to give a calcium chloride solution and ammonia gas. The calcium chloride solution is then contacted with soda ash to produce by double decomposition precipitated calcium carbonate and a solution of sodium chloride. The crystals can be produced in a variety of different shapes and sizes, depending on the specific reaction process that is used. The three main forms of PCC crystals are aragonite, rhombohedral and scalenohedral (e.g., calcite), all of which are suitable for use in the present invention, including mixtures thereof.

In certain embodiments of the first and second aspect, the PCC may be formed during the process of producing microfibrillated cellulose.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate.

When the inorganic particulate material of the present invention is obtained from naturally occurring sources, it may be that some mineral impurities will contaminate the ground material. For example, naturally occurring calcium carbonate can be present in association with other minerals. Thus, in some embodiments, the inorganic particulate material includes an amount of impurities. In general, however, the inorganic particulate material used in the invention will contain less than about 5% by weight, or less than about 1% by weight, of other mineral impurities.

The inorganic particulate material may have a particle size distribution in which at least about 10% by weight of the particles have an e.s.d of less than 2 μm, for example, at least about 20% by weight, or at least about 30% by weight, or at least about 40% by weight, or at least about 50% by weight, or at least about 60% by weight, or at least about 70% by weight, or at least about 80% by weight, or at least about 90% by weight, or at least about 95% by weight, or about 100% of the particles have an e.s.d of less than 2 μm.

In another embodiment of the first and second aspect, the inorganic particulate material has a particle size distribution, as measured using a Malvern Insitec or 3000 machine, in which at least about 10% by volume of the particles have an e.s.d of less than 2 μm, for example, at least about 20% by volume, or at least about 30% by volume, or at least about 40% by volume, or at least about 50% by volume, or at least about 60% by volume, or at least about 70% by volume, or at least about 80% by volume, or at least about 90% by volume, or at least about 95% by volume, or about 100% of the particles by volume have an e.s.d of less than 2 μm.

Details of the procedure used to characterize the particle size distributions of mixtures of inorganic particle material and microfibrillated cellulose using a Malvern Insitec or 3000 machine are provided below.

In certain embodiments of the first and second aspect, the inorganic particulate material is kaolin clay. Hereafter, this section of the specification may tend to be discussed in terms of kaolin, and in relation to aspects where the kaolin is processed and/or treated. The invention should not be construed as being limited to such embodiments. Thus, in some embodiments, kaolin is used in an unprocessed form.

Kaolin clay used in this invention may be a processed material derived from a natural source, namely raw natural kaolin clay mineral. The processed kaolin clay may typically contain at least about 50% by weight kaolinite. For example, most commercially processed kaolin clays contain greater than about 75% by weight kaolinite and may contain greater than about 90%, in some cases greater than about 95% by weight of kaolinite.

Kaolin clay used in the present invention may be prepared from the raw natural kaolin clay mineral by one or more other processes which are well known to those skilled in the art, for example by known refining or beneficiation steps.

For example, the clay mineral may be bleached with a reductive bleaching agent, such as sodium hydrosulfite. If sodium hydrosulfite is used, the bleached clay mineral may optionally be dewatered, and optionally washed and again optionally dewatered, after the sodium hydrosulfite bleaching step.

The clay mineral may be treated to remove impurities, e. g. by flocculation, flotation, or magnetic separation techniques well known in the art. Alternatively the clay mineral used in the first aspect of the invention may be untreated in the form of a solid or as an aqueous suspension.

The process for preparing the particulate kaolin clay used in the present invention may also include one or more comminution steps, e.g., grinding or milling. Light comminution of a coarse kaolin is used to give suitable delamination thereof. The comminution may be carried out by use of beads or granules of a plastic (e. g. nylon), sand or ceramic grinding or milling aid. The coarse kaolin may be refined to remove impurities and improve physical properties using well known procedures. The kaolin clay may be treated by a known particle size classification procedure, e.g., screening and centrifuging (or both), to obtain particles having a desired d₅₀ value or particle size distribution.

The Substrate

The substrate (and, optionally, the microfibrillated cellulose) may be derived from the same or a different cellulose-containing pulp, which may have been prepared by any suitable chemical or mechanical treatment, or combination thereof, which is well known in the art. The pulp may be derived from any suitable source such as wood, grasses (e.g., sugarcane, bamboo) or rags (e.g., textile waste, cotton, hemp or flax). The pulp may be bleached in accordance with processes which are well known to those skilled in the art and those processes suitable for use in the present invention will be readily evident. In certain embodiments, the pulp is unbleached. The bleached or unbleached cellulose pulp may be beaten, refined, or both, to a predetermined freeness (reported in the art as Canadian standard freeness (CSF) in cm³). A suitable stock is then prepared from the bleached or unbleached and beaten pulp.

In certain embodiments of the first and second aspect, the substrate comprises or is derived from a Kraft pulp, which is naturally colored (i.e., unbleached). In certain embodiments, the substrate comprises or is derived from unbleached Kraft pulp, recycled pulp, or combinations thereof. In certain embodiments of the first and second aspect, the substrate comprises or is derived from recycled pulp.

In other embodiments of the first and second aspect, the pulp is obtained from a chemical pulp, or a chemithermomechanical pulp, or a mechanical pulp, or thermomechanical pulp, including, for example, Northern Bleached Softwood Kraft pulp (“NB SK”), Bleached hardwood pulp, Bleached Chemi-Thermo Mechanical Pulp (“BCTMP”), or a recycled pulp, or a paper broke pulp, or a papermill waste stream, or waste from a papermill, or combinations thereof.

The stock from which the substrate is prepared may contain other additives known in the art. For example, the stock contains a non-ionic, cationic or an anionic retention aid or microparticle retention system. It may also contain a sizing agent which may be, for example, a long chain alkylketene dimer (“AKD”), a wax emulsion or a succinic acid derivative, e.g., alkenylsuccinic anhydride (“ASA”), rosin plus alum or cationic rosin emulsions. The stock for the substrate composition may also contain dye and/or an optical brightening agent. The stock may also comprise dry and wet strength aids such as, for example, starch or epichlorhydrin copolymer.

The Product

There are numerous types of paper or paperboard possible to be made with the disclosed compositions of microfibrillated cellulose and inorganic particulate materials and by the manufacturing processes described herein. There is no clear demarcation between paper and paperboard products. The latter tend to be thicker paper-based materials with increased grammages. Paperboard may be a single ply, to which the top ply of a composite of microfibrillated cellulose and inorganic particulate material can be applied, or the paperboard may be a multi-ply substrate. The present invention is directed to numerous forms of paperboard, including, by way of example and not limitation, boxboard or cartonboard, including folding cartons and rigid set-up boxes and folding boxboard; e.g. a liquid packaging board. The paperboard may be chipboard or white lined chipboard. The paperboard may be a Kraft board, laminated board. The paperboard may be a solid bleached board or a solid unbleached board. Various forms of containerboard are subsumed within the paperboard products of the present invention such as corrugated fibreboard (which is a building material and not a paper or paperboard product per se), linerboard or a binder's board. The paperboard described herein may be suitable for wrapping and packaging a variety of end-products, including for example foods.

In certain embodiments, the product is or comprises linerboard, and the substrate and top ply are suitable for use in or as linerboard. In certain embodiments, the product is or comprises one of brown Kraft liner, white top Kraft liner, test liner, white top test liner, brown light weight recycled liner, mottled test liner, and white top recycled liner.

In certain embodiments of the first and second aspect, the product is or comprises cartonboard.

In certain embodiments of the first and second aspect, the product is or comprises Kraft paper.

In certain embodiments of the first and second aspect, the substrate comprises a paperboard product or is suitable for use in or as a paperboard product. In certain embodiments, the substrate is suitable for use in a white top paperboard product, for example, as linerboard. In certain embodiments, the product comprises or is a paperboard product, for example, linerboard. In certain embodiments, the product comprises or is a white top paperboard product, for example, linerboard. In such embodiments, the paperboard product may be corrugated board, for example, having the product comprising substrate and top ply as linerboard. In certain embodiments, the paperboard product is single face, single wall, double wall or triple wall corrugated.

In certain embodiments of the first and second aspect, the substrate has a grammage of from about 75 g/m² to about 400 g/m², for example, from about 100 g/m² to about 375 g/m², or from about 100 g/m² to about 350 g/m², or from about 100 g/m² to about 300 g/m², or from about 100 g/m² to about 275 g/m², or from about 100 g/m² to about 250 g/m², or from about 100 g/m² to about 225 g/m², or from about 100 g/m² to about 200 g/m². In this and other embodiments, the top ply may have a grammage ranging from about 15 g/m² to 40 g/m², or from about 25 g/m² to 35 g/m².

In certain embodiments of the first and second aspect, the top ply has a grammage which is equal to or less than 40 g/m², or equal to or less than about 35 g/m², or equal to or less than about 30 g/m², or equal to or less than 25 g/m², or equal to or less than 22.5 g/m², or equal to or less than 20 g/m², or equal to or less than 18 g/m², or equal to or less than 15 g/m².

In certain barrier coating embodiments of the first and second aspect, the top ply has a grammage as a barrier coating is between 1 and 10 gsm, or between 1 and 5 gsm, or between or between 2 and 8 gsm, or between 3 and 6 gsm, or between 2 and 4 gsm.

Advantageously, the application of a top ply comprising inorganic particulate material and microfibrillated cellulose enables manufacture of a product, for example, paperboard or linerboard, having a combination of desirable optical, surface and mechanical properties, which are obtainable while utilizing relatively low amounts of a top ply having a high filler content, thereby offering light-weighting of the product compared to conventional top ply/substrate configurations. Another benefit is that application of a top ply in accordance with the first aspect of the present invention can result in a substantial reduction in the amount of fibre raw material required to produce the paper or board products of the first aspect of the present invention. Further, any reduction in mechanical properties which may occur following application of the top ply may be offset by increasing the grammage of the substrate, which is a relatively cheaper material, thereby recovering strength properties.

Therefore, in certain embodiments of the first and second aspect, the product has one or more of the following: a brightness measured (according to ISO Standard 11475 (F8; D65-400 nm)) on the top ply which is increased compared to the substrate absent of the top ply or measured on the substrate on a surface opposite the top ply and/or a brightness measured on the top ply of a least about 60.0% according to ISO Standard 11475 (F8; D65-400 nm).

In certain embodiments of the first and second aspect, a brightness measured on the top ply is at least about 70.0%, for example, at least about 75.0%, or at least about 80.0%, or at least about 81.0%, or at least about 82.0%, or at least about 83.0%, or at least about 84.0%, or at least about 85.0%. Brightness may be measured using an Elrepho spectrophotometer.

In certain embodiments of the first and second aspect, the top ply has a grammage of from about 30 to 50 g/m², a brightness of at least about 65.0%, and, optionally, a PPS roughness of less than about 5.6 μm.

In certain embodiments of the first and second aspect, the product comprises a further layer or ply, or further layers or plies, on the ply comprising at least about 50 wt. % microfibrillated cellulose. For example, one or more layers or plies, or at least two further layers or plies, or up to about five further layers or plies, or up to about four further layers or plies, or up to about three further layers or plies.

In certain embodiments of the first and second aspect, one of, or at least one of the further layers or plies is a barrier layer or ply, or wax layer or ply, or silicon layer or ply, or a combination of two or three of such layers.

Another advantageous feature of the disclosed top ply coated substrates comprising microfibrillated cellulose or microfibrillated cellulose inorganic particulate material is improved printing on the top ply. A conventional white top liner typically has a white surface consisting of a white paper with relatively low filler content, typically in the 5-15% filler range. As a result, such white top liners tend to be quite rough and open with a coarse pore structure. This is not ideal for receiving printing ink.

Methods of Manufacturing Microfibrillated Cellulose and Inorganic Particulate Material

In certain embodiments of the first and second aspect, the microfibrillated cellulose may be prepared in the presence of or in the absence of the inorganic particulate material.

The microfibrillated cellulose is derived from fibrous substrate comprising cellulose. The fibrous substrate comprising cellulose may be derived from any suitable source, such as wood, grasses (e.g., sugarcane, bamboo) or rags (e.g., textile waste, cotton, hemp or flax). The fibrous substrate comprising cellulose may be in the form of a pulp (i.e., a suspension of cellulose fibers in water), which may be prepared by any suitable chemical or mechanical treatment, or combination thereof. For example, the pulp may be a chemical pulp, or a chemi-thermomechanical pulp, or a mechanical pulp, or a recycled pulp, or a papermill broke, or a papermill waste stream, or waste from a papermill, or a dissolving pulp, kenaf pulp, market pulp, partially carboxymethylated pulp, abaca pulp, hemlock pulp, birch pulp, grass pulp, bamboo pulp, palm pulp, peanut shell, or a combination thereof. The cellulose pulp may be beaten (for example, in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained. For example, the cellulose pulp may have a Canadian standard freeness of about 10 cm³ or greater prior to being microfibrillated. The cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³.

In certain embodiments of the first and second aspect, the pulp is obtained from a chemical pulp, or a chemithermomechanical pulp, or a mechanical pulp, or thermomechanical pulp, including, for example, Northern Bleached Softwood Kraft pulp (“NB SK”), Bleached hardwood pulp, Bleached Chemi-Thermo Mechanical Pulp (“BCTMP”), or a recycled pulp, or a paper broke pulp, or a papermill waste stream, cor waste from a papermill, or combinations thereof.

The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilised in an unrefined state, which is to say without being beaten or dewatered, or otherwise refined.

In certain embodiments of the first and second aspect, the pulp may be beaten in the presence of an inorganic particulate material, such as calcium carbonate.

Co-Grinding Process of Microfibrillated Cellulose and Inorganic Particulate Material

In an embodiment of the first and second aspect, the present invention is related to modifications, for example, improvements, to the methods and compositions described in WO-A-2010/131016, the entire contents of which are hereby incorporated by reference.

WO-A-2010/131016 discloses a process for preparing microfibrillated cellulose comprising microfibrillating, e.g., by grinding a fibrous material comprising cellulose, optionally in the presence of grinding medium and/or inorganic particulate material. When used as a filler in paper, for example, as a replacement or partial replacement for a conventional mineral filler, the microfibrillated cellulose obtained by said process, optionally in combination with inorganic particulate material, was unexpectedly found to improve the burst strength properties of the paper. That is, relative to a paper filled with exclusively mineral filler, paper filled with the microfibrillated cellulose was found to have improved burst strength. In other words, the microfibrillated cellulose filler was found to have paper burst strength enhancing attributes. In one particularly advantageous embodiment of that invention, the fibrous material comprising cellulose was ground in the presence of a grinding medium, optionally in combination with inorganic particulate material, to obtain microfibrillated cellulose having a fibre steepness of from 20 to about 50.

In further embodiments of the foregoing aspects and embodiments of the present invention, the methods of manufacturing a partially-dried sheet comprising, consisting essentially of, or consisting of, microfibrillated cellulose suitable for use as a binder, or a dried sheet comprising, consisting essentially of, or consisting of, a blend of microfibrillated cellulose and a pulp suitable for use as a pulp source, wherein said sheet may be redispersed with a high shear disperser, mixer or refiner operated at energy inputs of about 10 kWh/t to about 2,000 kWh/t, wherein the sheet upon re-dispersion in an aqueous medium maintains, or is not substantially degraded in, tensile index, compared to the dried sheet prior to drying and re-dispersion, and wherein the microfibrillated cellulose has a fibre steepness of from about 20 to about 50, may be obtained by a method comprising making a co-grinding composite of microfibrillated cellulose and inorganic particulate material.

For preparation of microfibrillated cellulose, the fibrous substrate comprising cellulose may be added to a grinding vessel or homogenizer in a dry state. For example, a dry paper broke may be added directly to a grinder vessel. The aqueous environment in the grinder vessel will then facilitate the formation of a pulp.

The step of microfibrillating may be carried out in any suitable apparatus, including but not limited to a refiner. In one embodiment, the microfibrillating step is conducted in a grinding vessel under wet-grinding conditions. In another embodiment, the microfibrillating step is carried out in a homogenizer. Each of these embodiments is described in greater detail below.

Wet Grinding

The grinding is suitably performed in a conventional manner. The grinding may be an attrition grinding process in the presence of a particulate grinding medium, or may be an autogenous grinding process, i.e., one in the absence of a grinding medium. By grinding medium is meant to be a medium other than the inorganic particulate material which in certain embodiments may be co-ground with the fibrous substrate comprising cellulose.

The particulate grinding medium, when present, may be of a natural or a synthetic material. The grinding medium may, for example, comprise balls, beads or pellets of any hard mineral, ceramic or metallic material. Such materials may include, for example, alumina, zirconia, zirconium silicate, aluminium silicate or the mullite-rich material which is produced by calcining kaolinitic clay at a temperature in the range of from about 1300° C. to about 1800° C. For example, in some embodiments a Carbolite® grinding media is used. Alternatively, particles of natural sand of a suitable particle size may be used.

In other embodiments, hardwood grinding media (e.g., wood flour) may be used.

Generally, the type of and particle size of grinding medium to be selected for use in the invention may be dependent on the properties, such as, e.g., the particle size of, and the chemical composition of, the feed suspension of material to be ground. In some embodiments, the particulate grinding medium comprises particles having an average diameter in the range of from about 0.1 mm to about 6.0 mm, for example, in the range of from about 0.2 mm to about 4.0 mm. The grinding medium (or media) may be present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

The grinding may be carried out in one or more stages. For example, a coarse inorganic particulate material may be ground in the grinder vessel to a predetermined particle size distribution, after which the fibrous material comprising cellulose is added and the grinding continued until the desired level of microfibrillation has been obtained.

The inorganic particulate material may be wet or dry ground in the absence or presence of a grinding medium. In the case of a wet grinding stage, the coarse inorganic particulate material is ground in an aqueous suspension in the presence of a grinding medium.

In an embodiment of the first and second aspect, the median particle size (d₅₀) of the inorganic particulate material is reduced during the co-grinding process. For example, the d₅₀ of the inorganic particulate material may be reduced by at least about 10% (as measured by a Malvern Insitec or 3000 machine), for example, the d₅₀ of the inorganic particulate material may be reduced by at least about 20%, or reduced by at least about 30%, or reduced by at least about 50%, or reduced by at least about 50%, or reduced by at least about 60%, or reduced by at least about 70%, or reduced by at least about 80%, or reduced by at least about 90%. For example, an inorganic particulate material having a d₅₀ of 2.5 μm prior to co-grinding and a d₅₀ of 1.5 μm post co-grinding will have been subject to a 40% reduction in particle size.

In certain embodiments of the first and second aspect, the median particle size of the inorganic particulate material is not significantly reduced during the co-grinding process. By ‘not significantly reduced’ is meant that the d₅₀ of the inorganic particulate material is reduced by less than about 10%, for example, the d₅₀ of the inorganic particulate material is reduced by less than about 5%.

The fibrous substrate comprising cellulose may be microfibrillated, optionally in the presence of an inorganic particulate material, to obtain microfibrillated cellulose having a d₅₀ ranging from about 5 to μm about 500 μm, as measured by laser light scattering. The fibrous substrate comprising cellulose may be microfibrillated, optionally in the presence of an inorganic particulate material, to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated, optionally in the presence of an inorganic particulate material, to obtain microfibrillated cellulose having a modal fibre particle size ranging from about 0.1-500 μm and a modal inorganic particulate material particle size ranging from 0.25-20 μm. The fibrous substrate comprising cellulose may be microfibrillated, optionally in the presence of an inorganic particulate material to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated, optionally in the presence of an inorganic particulate material, to obtain microfibrillated cellulose having a fibre steepness, as described above.

The grinding may be performed in a grinding vessel, such as a tumbling mill (e.g., rod, ball and autogenous), a stirred mill (e.g., SAM or Isa Mill), a tower mill, a stirred media detritor (SMD), or a grinding vessel comprising rotating parallel grinding plates between which the feed to be ground is fed.

In an embodiment of the first and second aspect, the grinding vessel is a tower mill. The tower mill may comprise a quiescent zone above one or more grinding zones. A quiescent zone is a region located towards the top of the interior of tower mill in which minimal or no grinding takes place and comprises microfibrillated cellulose and optional inorganic particulate material. The quiescent zone is a region in which particles of the grinding medium sediment down into the one or more grinding zones of the tower mill.

The tower mill may comprise a classifier above one or more grinding zones. In an embodiment, the classifier is top mounted and located adjacent to a quiescent zone. The classifier may be a hydrocyclone.

The tower mill may comprise a screen above one or more grind zones. In an embodiment, a screen is located adjacent to a quiescent zone and/or a classifier. The screen may be sized to separate grinding media from the product aqueous suspension comprising microfibrillated cellulose and optional inorganic particulate material and to enhance grinding media sedimentation.

In an embodiment of the first and second aspect, the grinding is performed under plug flow conditions. Under plug flow conditions the flow through the tower is such that there is limited mixing of the grinding materials through the tower. This means that at different points along the length of the tower mill the viscosity of the aqueous environment will vary as the fineness of the microfibrillated cellulose increases. Thus, in effect, the grinding region in the tower mill can be considered to comprise one or more grinding zones which have a characteristic viscosity. A skilled person in the art will understand that there is no sharp boundary between adjacent grinding zones with respect to viscosity.

In an embodiment of the first and second aspect, water is added at the top of the mill proximate to the quiescent zone or the classifier or the screen above one or more grinding zones to reduce the viscosity of the aqueous suspension comprising microfibrillated cellulose and optional inorganic particulate material at those zones in the mill. By diluting the product microfibrillated cellulose and optional inorganic particulate material at this point in the mill it has been found that the prevention of grinding media carry over to the quiescent zone and/or the classifier and/or the screen is improved. Further, the limited mixing through the tower allows for processing at higher solids lower down the tower and dilute at the top with limited backflow of the dilution water back down the tower into the one or more grinding zones. Any suitable amount of water which is effective to dilute the viscosity of the product aqueous suspension comprising microfibrillated cellulose and optional inorganic particulate material may be added. The water may be added continuously during the grinding process, or at regular intervals, or at irregular intervals.

In another embodiment of the first and second aspect, water may be added to one or more grinding zones via one or more water injection points positioned along the length of the tower mill, or each water injection point being located at a position which corresponds to the one or more grinding zones. Advantageously, the ability to add water at various points along the tower allows for further adjustment of the grinding conditions at any or all positions along the mill.

The tower mill may comprise a vertical impeller shaft equipped with a series of impeller rotor disks throughout its length. The action of the impeller rotor disks creates a series of discrete grinding zones throughout the mill.

In another embodiment of the first and second aspect, the grinding is performed in a screened grinder, such as a stirred media detritor. The screened grinder may comprise one or more screen(s) having a nominal aperture size of at least about 250 μm, for example, the one or more screens may have a nominal aperture size of at least about 300 μm, or at least about 350 μm, or at least about 400 μm, or at least about 450 μm, or at least about 500 μm, or at least about 550 μm, or at least about 600 μm, or at least about 650 μm, or at least about 700 μm, or at least about 750 μm, or at least about 800 μm, or at least about 850 μm, or at or least about 900 μm, or at least about 1000 μm.

The screen sizes noted immediately above are applicable to the tower mill embodiments described above.

As noted above, the grinding may be performed in the presence of a grinding medium. In an embodiment of the first and second aspect, the grinding medium is a coarse media comprising particles having an average diameter in the range of from about 1 mm to about 6 mm, for example about 2 mm, or about 3 mm, or about 4 mm, or about 5 mm.

In another embodiment of the first and second aspect, the grinding media has a specific gravity of at least about 2.5, for example, at least about 3, or at least about 3.5, or at least about 4.0, or at least about 4.5, or least about 5.0, or at least about 5.5, or at least about 6.0.

In another embodiment of the first and second aspect, the grinding media comprises particles having an average diameter in the range of from about 1 mm to about 6 mm and has a specific gravity of at least about 2.5.

In another embodiment of the first and second aspect, the grinding media comprises particles having an average diameter of about 3 mm and specific gravity of about 2.7.

As described above, the grinding medium (or media) may present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

In an embodiment of the first and second aspect, the grinding medium is present in amount of about 50% by volume of the charge.

The term ‘charge’ is meant to be the composition which is the feed fed to the grinder vessel. The charge includes of water, grinding media, fibrous substrate comprising cellulose and optional inorganic particulate material, and any other optional additives as described herein.

The use of a relatively coarse and/or dense media has the advantage of improved (i.e., faster) sediment rates and reduced media carry over through the quiescent zone and/or classifier and/or screen(s).

A further advantage in using relatively coarse grinding media is that the mean particle size (d₅₀) of the inorganic particulate material may not be significantly reduced during the grinding process such that the energy imparted to the grinding system is primarily expended in microfibrillating the fibrous substrate comprising cellulose.

A further advantage in using relatively coarse screens is that a relatively coarse or dense grinding media can be used in the microfibrillating step. In addition, the use of relatively coarse screens (i.e., having a nominal aperture of least about 250 μm) allows a relatively high solids product to be processed and removed from the grinder, which allows a relatively high solids feed (comprising fibrous substrate comprising cellulose and inorganic particulate material) to be processed in an economically viable process. As discussed below, it has been found that a feed having high initial solids content is desirable in terms of energy sufficiency. Further, it has also been found that product produced (at a given energy) at lower solids has a coarser particle size distribution.

The grinding may be performed in a cascade of grinding vessels, one or more of which may comprise one or more grinding zones. For example, the fibrous substrate comprising cellulose and the inorganic particulate material may be ground in a cascade of two or more grinding vessels, for example, a cascade of three or more grinding vessels, or a cascade of four or more grinding vessels, or a cascade of five or more grinding vessels, or a cascade of six or more grinding vessels, or a cascade of seven or more grinding vessels, or a cascade of eight or more grinding vessels, or a cascade of nine or more grinding vessels in series, or a cascade comprising up to ten grinding vessels. The cascade of grinding vessels may be operatively linked in series or parallel or a combination of series and parallel. The output from and/or the input to one or more of the grinding vessels in the cascade may be subjected to one or more screening steps and/or one or more classification steps.

The circuit may comprise a combination of one or more grinding vessels and homogenizer.

In an embodiment the grinding is performed in a closed circuit. In another embodiment, the grinding is performed in an open circuit. The grinding may be performed in batch mode. The grinding may be performed in a re-circulating batch mode.

As described above, the grinding circuit may include a pre-grinding step in which coarse inorganic particulate ground in a grinder vessel to a predetermined particle size distribution, after which fibrous material comprising cellulose is combined with the pre-ground inorganic particulate material and the grinding continued in the same or different grinding vessel until the desired level of microfibrillation has been obtained.

As the suspension of material to be ground may be of a relatively high viscosity, a suitable dispersing agent may be added to the suspension prior to grinding. The dispersing agent may be, for example, a water soluble condensed phosphate, polysilicic acid or a salt thereof, or a polyelectrolyte, for example a water soluble salt of a poly(acrylic acid) or of a poly(methacrylic acid) having a number average molecular weight not greater than 80,000. The amount of the dispersing agent used would generally be in the range of from 0.1 to 2.0% by weight, based on the weight of the dry inorganic particulate solid material. The suspension may suitably be ground at a temperature in the range of from 4° C. to 100° C.

Other additives which may be included during the microfibrillation step include: carboxymethyl cellulose, amphoteric carboxymethyl cellulose, oxidising agents, 2,2,6,6-Tetramethylpiperidine-1-oxyl (TEMPO), TEMPO derivatives, and wood degrading enzymes.

The pH of the suspension of material to be ground may be about 7 or greater than about 7 (i.e., basic), for example, the pH of the suspension may be about 8, or about 9, or about 10, or about 11. The pH of the suspension of material to be ground may be less than about 7 (i.e., acidic), for example, the pH of the suspension may be about 6, or about 5, or about 4, or about 3. The pH of the suspension of material to be ground may be adjusted by addition of an appropriate amount of acid or base. Suitable bases included alkali metal hydroxides, such as, for example, NaOH. Other suitable bases are sodium carbonate and ammonia. Suitable acids included inorganic acids, such as hydrochloric and sulphuric acid, or organic acids. An exemplary acid is orthophosphoric acid.

The amount of inorganic particulate material, when present, and cellulose pulp in the mixture to be co-ground may be varied in order to produce a slurry which is suitable for use as the top ply slurry, or ply slurry, or which may be further modified, e.g., with additional of further inorganic particulate material, to produce a slurry which is suitable for use as the top ply slurry, or ply slurry.

### Homogenizing

Microfibrillation of the fibrous substrate comprising cellulose may be effected under wet conditions, optionally, in the presence of the inorganic particulate material, by a method in which the mixture of cellulose pulp and optional inorganic particulate material is pressurized (for example, to a pressure of about 500 bar) and then passed to a zone of lower pressure. The rate at which the mixture is passed to the low pressure zone is sufficiently high and the pressure of the low pressure zone is sufficiently low as to cause microfibrillation of the cellulose fibers. For example, the pressure drop may be effected by forcing the mixture through an annular opening that has a narrow entrance orifice with a much larger exit orifice. The drastic decrease in pressure as the mixture accelerates into a larger volume (i.e., a lower pressure zone) induces cavitation which causes microfibrillation. In an embodiment, microfibrillation of the fibrous substrate comprising cellulose may be effected in a homogenizer under wet conditions, optionally in the presence of the inorganic particulate material. In the homogenizer, the cellulose pulp and optional inorganic particulate material is pressurized (for example, to a pressure of about 500 bar), and forced through a small nozzle or orifice. The mixture may be pressurized to a pressure of from about 100 to about 1000 bar, for example to a pressure of equal to or greater than 300 bar, or equal to or greater than about 500, or equal to or greater than about 200 bar, or equal to or greater than about 700 bar. The homogenization subjects the fibers to high shear forces such that as the pressurized cellulose pulp exits the nozzle or orifice, cavitation causes microfibrillation of the cellulose fibers in the pulp. Additional water may be added to improve flowability of the suspension through the homogenizer. The resulting aqueous suspension comprising microfibrillated cellulose and optional inorganic particulate material may be fed back into the inlet of the homogenizer for multiple passes through the homogenizer. When present, and when the inorganic particulate material is a naturally platy mineral, such as kaolin, homogenization not only facilitates microfibrillation of the cellulose pulp, but may also facilitate delamination of the platy particulate material.

An exemplary homogenizer is a Manton Gaulin (APV) homogenizer.

After the microfibrillation step has been carried out, the aqueous suspension comprising microfibrillated cellulose and optional inorganic particulate material may be screened to remove fibre above a certain size and to remove any grinding medium. For example, the suspension can be subjected to screening using a sieve having a selected nominal aperture size in order to remove fibers which do not pass through the sieve. Nominal aperture size means the nominal central separation of opposite sides of a square aperture or the nominal diameter of a round aperture. The sieve may be a BSS sieve (in accordance with BS 1796) having a nominal aperture size of 150 μm, for example, a nominal aperture size 125 μm, or 106 μm, or 90 μm, or 74 μm, or 63 μm, or 53 μm, 45 μm, or 38 μm. In one embodiment, the aqueous suspension is screened using a BSS sieve having a nominal aperture of 125 μm. The aqueous suspension may then be optionally dewatered.

It will be understood therefore that amount (i.e., % by weight) of microfibrillated cellulose in the aqueous suspension after grinding or homogenizing may be less than the amount of dry fibre in the pulp if the ground or homogenized suspension is treated to remove fibers above a selected size. Thus, the relative amounts of pulp and optional inorganic particulate material fed to the grinder or homogenizer can be adjusted depending on the amount of microfibrillated cellulose that is required in the aqueous suspension after fibers above a selected size are removed.

In certain embodiments of the first and second aspect, the microfibrillated cellulose may be prepared by a method comprising a step of microfibrillating the fibrous substrate comprising cellulose in an aqueous environment by grinding in the presence of a grinding medium (as described herein), wherein the grinding is carried out in the absence of inorganic particulate material. In certain embodiments, inorganic particulate material may be added after grinding to produce the top ply slurry, or ply slurry.

In certain embodiments of the first and second aspect, the grinding medium is removed after grinding.

In other embodiments of the first and second aspect, the grinding medium is retained after grinding and may serve as the inorganic particulate material, or at least a portion thereof. In certain embodiments, additional inorganic particulate may be added after grinding to produce the top ply slurry, or ply slurry.

The following procedure may be used to characterise the particle size distributions of mixtures of inorganic particulate material (e.g., GCC or kaolin) and microfibrillated cellulose pulp fibers.

Calcium Carbonate

A sample of co-ground slurry sufficient to give 3 g dry material is weighed into a beaker, diluted to 60 g with deionised water, and mixed with 5 cm³ of a solution of sodium polyacrylate of 1.5 w/v % active. Further deionised water is added with stirring to a final slurry weight of 80 g.

Kaolin

A sample of co-ground slurry sufficient to give 5 g dry material is weighed into a beaker, diluted to 60 g with deionised water, and mixed with 5 cm³ of a solution of 1.0 wt. % sodium carbonate and 0.5 wt. % sodium hexametaphosphate. Further deionised water is added with stirring to a final slurry weight of 80 g.

The slurry is then added in 1 cm³ aliquots to water in the sample preparation unit attached to the Insitec or 3000 until the optimum level of obscuration is displayed (normally 10-15%). The light scattering analysis procedure is then carried out. The instrument range selected was 300RF: 0.05-900, and the beam length set to 2.4 mm.

For co-ground samples containing calcium carbonate and fibre the refractive index for calcium carbonate (1.596) is used. For co-ground samples of kaolin and fibre the RI for kaolin (1.5295) is used.

The particle size distribution is calculated from Mie theory and gives the output as a differential volume based distribution. The presence of two distinct peaks is interpreted as arising from the mineral (finer peak) and fibre (coarser peak).

The finer mineral peak is fitted to the measured data points and subtracted mathematically from the distribution to leave the fibre peak, which is converted to a cumulative distribution. Similarly, the fibre peak is subtracted mathematically from the original distribution to leave the mineral peak, which is also converted to a cumulative distribution. Both these cumulative curves may then be used to calculate the median particle size (d₅₀) and the steepness of the distribution (d₃₀/d₇₀×100). The differential curve may be used to find the modal particle size for both the mineral and fibre fractions.

Methods of Manufacture

The main process conditions found to be important for applying a top ply slurry comprising microfibrillated cellulose or comprising microfibrillated cellulose and one or more inorganic particulate material to a forming web of paper at the wet end of a papermaking machine include coating grammage, the solids content of the top ply slurry comprising microfibrillated cellulose or comprising microfibrillated cellulose and one or more inorganic particulate material used in the coating, the MFC content (Percentage of Pulp; % POP), the inorganic particulate material used, the applicator slot thickness and the jet/web velocity ratio. These conditions are somewhat interdependent, but can be stated in acceptable ranges for the process of the present invention.

MFC content (% POP). For white top liner, the MFC content is typically around 20% POP or 15% POP. The slurry composition in terms of % MFC, is optimally between about 15 wt. % and about 25 wt. %, based on the total weight of the top ply. The slurry composition in terms of % MFC may be between about 5 wt. % to about 30 wt. %, based on the total weight of the top ply.

Grammage is typically in the range of between 15 and 40 gsm for the white top application. Coverage within this range is sufficient for a brightness of 65-80 on a typical base paper or board. For the paper and board products made from recycled pulp grades, a larger grammage may be necessary to produce a higher brightness.

Mineral type. Typically, the particle size of the one or more inorganic particulate material is between 25 wt. % and 95 wt. % less than 2 μm equivalent spherical diameter (“esd”). Certain inorganic particulate materials, for example, scalenohedral PCC, maximize the drainage rate. To increase the drainage rate, minerals with a steep particle size distribution and/or hard-aggregated minerals should be used. Methods of hard aggregation include calcining (for kaolin) and precipitation of calcium carbonate under suitable conditions. The oil absorption test is useful for aggregated minerals, which promote fast drainage, although may impact printing results.

Solids content. For 20% POP paper and board products, an optimal range is from about 5% to 12% total solids, which, for example at 20% POP corresponds to 1.4-2% MFC.

Jet/web velocity ratio. Ideally the jet/web velocity ratio is above about 0.7. An optimal range is between 0.7 and 1.6, ideally between 0.8 and 1.4.

Slot thickness. Slot width is not independent of the foregoing variables. The typical slot width required is equal to the grammage/(jet web ratio×coating solids). Using the ranges specified above, the narrowest slot as 0.08 mm for a 15 gsm coating using a 12% solids slurry at a jet web ratio of 1.6, and the widest as 1.0 mm for a 50 gsm coating using a 7% solids slurry at a jet web ratio is 0.7. An optimal working range for slot thickness is about 0.1-1 mm.

A final process parameter to optimize the application of the top ply slurry in the present invention is utilization of MFC with a weighted average fibre length (called Lc(w) ISO in the instrument output) of less than 0.7 mm to avoid blockages of the slot. A Valmet FS5 fibre image analyser may be used to measure geometric parameters of the original fibers before grinding, and the MFC particles after grinding. The Valmet FS5 Fibre Image Analyser (from here onwards referred to as the “fibre analyser”) is a machine that is used to assess dimensions of fibers, such as length and width distributions. In such a test, a roughly 500 mL suspension of roughly 0.002 wt % fibre solids is produced, and loaded into the machine. The machine mixes the suspension, and pumps it through some transparent tubing past a camera. The camera takes thousands of pictures, and the fibre analyser software uses various algorithms in order to determine fibre dimensions and other geometric and morphological properties.

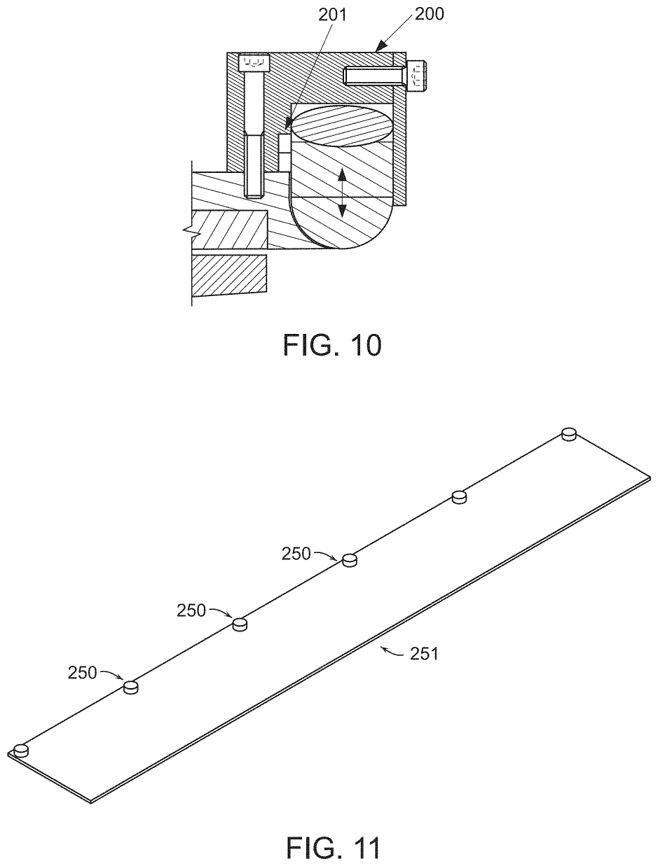

FIG. 10 compares this parameter with the proportion of fibers >300 μm as measured by fibre analyzer, with the blockage tendency indicated by the colour of the points.

This method is a ‘wet on wet’ method which is different than conventional paper coating methods in which an aqueous coating is applied to a substantially dry paper product (i.e., ‘wet on dry’.

In certain embodiments of the first and second aspect, the top ply slurry is provided in an amount ranging from 15 g/m² to 40 g/m². In certain embodiments the top ply slurry is provided in an amount ranging from about 3 g/m² to about 10 g/m² to form a barrier layer.

In certain embodiments of the first and second aspect, the top ply slurry comprises a sufficient amount of microfibrillated cellulose to obtain a product having the strength properties required for meeting end-use demands. Typically this would mean a top ply comprising at least about 5 wt. % microfibrillated cellulose, based on the total weight of top ply (i.e., the total dry weight of the top ply of the paper product).

Use of high solids compositions is desirable in the method because it leaves less water to drain. However, as is well known in the art, the solids level should not be so high that high viscosity and leveling problems are introduced.

In an embodiment of the first and second aspect, the top ply slurry is applied a coating to the substrate by a non-pressurized or pressurized slot opening on top of the wet substrate on the wire of the wet end of a paper machine, for example a Fourdrinier machine utilizing an applicator with a flexible blade.

In certain embodiments of the first and second aspect, the wet web of pulp comprises greater than about 50 wt. % of water, based on the total weight of the wet web of pulp, for example, at least about 60 wt. %, or at least about 70 wt. %, or at least about 80 wt. %, or at least about 90 wt. % of water, based on the total weight of the wet web of pulp. Typically, the wet web of pulp comprises about 85-95 wt. % water.

In certain embodiments of the first and second aspect, the top ply slurry has a total solids content of up to about 20 wt. %, for example, up to about 15 wt. %, or up to 12 wt. %, or up to about 10 wt. %, or from about 1 wt. % to about 10 wt. %, or from about 2 wt. % to 12 wt. %, or from about 5 wt. % to about 10 wt. %, or from about 1 wt. % to about 20 wt. %, or from about 2 wt. % to about 12 wt. %. The relative amounts of inorganic particulate material and microfibrillated cellulose may be varied depending on the amount of each component required in the final product comprising at least about 5 wt. % microfibrillated cellulose, based on the total weight of the top ply and such that the paper product has sufficient microfibrillated cellulose to obtain a paper product with the strength properties needed for its end-use application.

In certain embodiments of the first and second aspect, the top ply slurry comprises a sufficient amount of inorganic particulate material to obtain a paper product having a top ply comprising at least about 67 wt. % of inorganic particulate material, based on the total weight of the top ply of the paper product.

In such embodiments the objective is to incorporate as little microfibrillated cellulose with as much inorganic particulate material as possible on the surface of the substrate material as a top layer. Accordingly, ratios of 4:1 or greater of inorganic particulate material to microfibrillated cellulose in the top ply are preferred.

In certain embodiments of the first and second aspect, the top ply slurry has a total solids content of up to about 20 wt. %, for example, up to about 15 wt. %, or up to 12 wt. %, or up to about 10 wt. %, or from about 1 wt. % to about 10 wt. %, or from about 2 wt. % to 12 wt. %, or from about 5 wt. % to about 10 wt. %, or from about 1 wt. % to about 20 wt. %, or from about 2 wt. % to about 12 wt. %. The relative amounts of inorganic particulate material and microfibrillated cellulose may be varied depending on the amount of each component required in the final product.

Following application of the top ply slurry and appropriate dwell time, the paper product is pressed and dried using any suitable method.

Applicator with Flexible Blade

The flexible blade attachment of the first and second aspect of the present invention may be affixed to any applicator suitable for applying a liquid slurry comprising microfibrillated cellulose or a liquid slurry comprising microfibrillated cellulose and one or more inorganic particulate material, preferably an aqueous slurry, to a forming web of paper at the wet end of paper machine, wherein the applicator comprises a slot through which the slurry is delivered to the forming web of paper. For example, the flexible blade is attached above the opening of a slot die coater. The flexible blade functions to support the jet of slurry exiting the applicator slot as it travels to the forming web of paper below. The blade imparts shear to the slurry comprising microfibrillated cellulose or comprising microfibrillated cellulose and one or more inorganic particulate material by preventing viscosity recovery and flocculation of the liquid slurry, preferably an aqueous slurry.

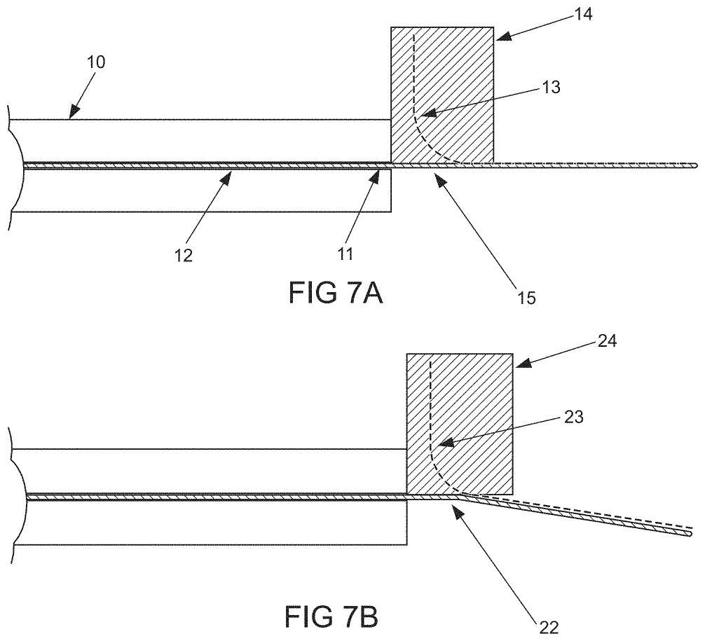

A general depiction of the flexible blade of the present invention in relation to the slot opening of any suitable slot applicator coater is shown in FIGS. 7A and 7B. A generic applicator (10) comprising a slot (11) for delivery of a top coat slurry (12) comprising microfibrillated cellulose or comprising microfibrillated cellulose and one or more inorganic particulate material, to a forming web of paper below (not shown) at the wet end of a paper machine (not shown), is depicted in FIG. 7A. A flexible blade (13) is shown affixed to a blade holder device (14) which is mounted above slot (11) of applicator (10), thereby holding the flexible blade (13) in an orientation at a controlled angle from substantially parallel to about 10° to about 45° relative to forming web of paper at the wet end of a paper machine. The flexible blade (13) is shown in a position parallel to the slurry (15) exiting slot (11) of applicator (10) in FIG. 7A.

Alternatively, a flexible blade (23) may be affixed to an adjustable blade holder device (24), thereby permitting positioning of the flexible blade (23) at a controlled angle to deflect and guide the slurry (22) in the direction of a forming web of paper below (not shown) at the wet end of a paper machine (not shown), as depicted in FIG. 7B.

Flexible blade 13 (or 23) can be added to any existing slot die applicator coater. The flexible blade (13) (or 23) is clamped in place by a blade holder (14) (or 24) that orients the flexible blade (13) (or 23) in a substantially parallel direction relative to the exiting jet of slurry (13), as shown in FIG. 7A, or at a controlled angle as shown in FIG. 7B.

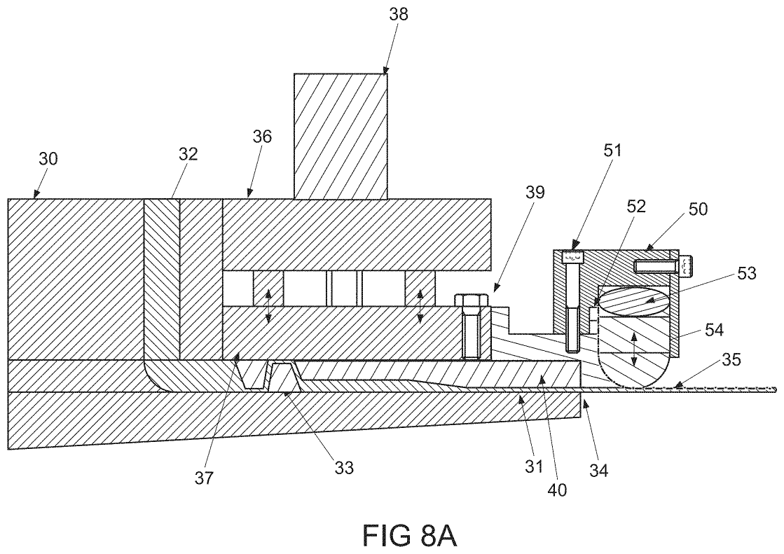

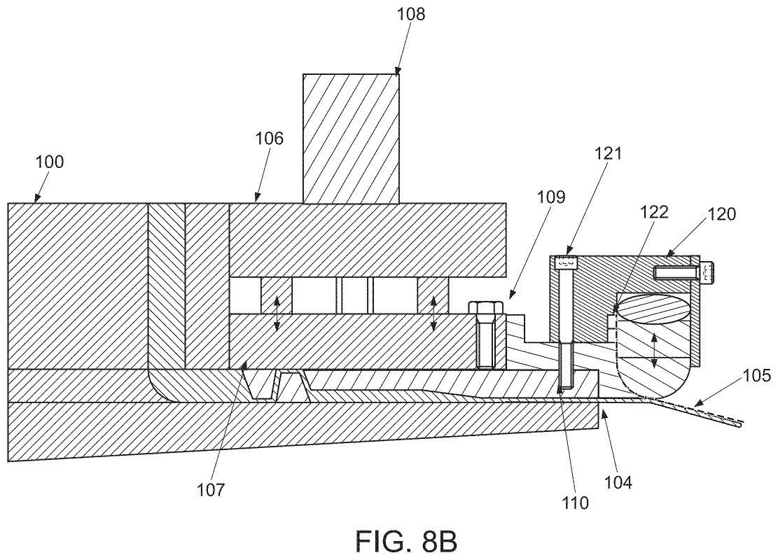

FIG. 8A depicts an embodiment of an applicator (30) for applying a top coating slurry comprising microfibrillated cellulose or comprising microfibrillated cellulose and one or more inorganic particulate material to forming web of paper below (not shown) at the wet end (not shown) of a paper machine (not shown). Generic applicator (30) has a channel (31) for introducing slurry (32). In FIG. 8A, channel 31 comprises one or more bars (33) in channel (31) for causing turbulence of the slurry (32) along the path of channel (31). Channel (31) terminates at slot (34) shown in cross-sectional view. Slurry (32) exits slot (34) in substantially parallel orientation to the underside of flexible blade (35), thus guiding slurry (32) at a shallow angle relative to the forming web of paper below (not shown).

Slot applicator (30) depicted in FIG. 8A further comprises fixed support (36) engaging movable support (37). Screw jack (38) attached to fixed support (36) permits controlling the height of slot (34). Profiling screw (39) is inserted through movable support (36) engaging the movable top lip member (40) of slot (34). Profiling screws (39) are evenly spaced across the width of the slot and enable localized control of the height of the channel to account for variations in flow across the width of the slot.

Also depicted in FIG. 8A is a blade holder (50) affixed by screw (51) to the movable lip member (40) shown in cross-sectional view. Blade holder (50) comprises a flexible blade (35) comprising metal tabs riveted to it across the width and these tabs slide into a slot (52) near the clamp from the end of the applicator. This allows for the blade to be aligned and easily changed during operation and keeps the blade in place regardless of whether the clamp tube is pressurized or not. FIG. 10 shows an expanded view of the blade holder (200) with the blade removed to show the slot (201) for the tabs (250) shown on flexible blade (251) in FIG. 11.

In FIG. 8A, blade holder (50) comprises inflatable tube (53) for operating clamp (54) engaging flexible blade (35) controlling it's angle relative to the slot (34).

FIG. 8B depicts slot applicator (100), which further comprises fixed support (106) engaging movable support (107). Screw jack (108) attached to fixed support (106) permits controlling the height of slot (104). Profiling screw (109) is inserted through movable support (106) engaging the movable top lip member (110) of slot (104). Profiling screws (109) are evenly spaced across the width of the slot and enable localized control of the height of the channel to account for variations in flow across the width of the slot (not shown).

Also depicted in FIG. 8B is a blade holder (120) affixed by screw (121) to the movable lip member (110) shown in cross-sectional view. Blade holder (120) comprises a flexible blade (105) comprising metal tabs riveted to it across the width and these tabs slide into a slot (122) near the clamp from the end of the applicator. This allows for the blade to be aligned easily, changed during operation and keeps the blade in place regardless if the clamp tube is pressurized or not. See FIG. 10 for an expanded view of the slot for the flexible blade with riveted tabs, as depicted in FIG. 11.

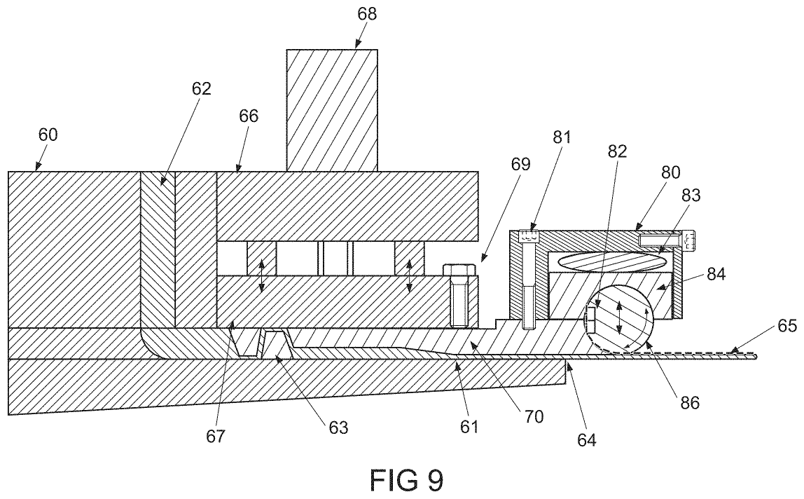

The blade length can be changed by replacing the blade with other dimensions in FIG. 8B or can be extended or retracted in FIG. 9, but also this exemplary feature can take blades of different lengths.

FIG. 9 depicts an adjustable angle and adjustable blade length device. A rotation of 180 degrees on the shaft can result in a 0-50 mm change in the blade length or more.

FIG. 9 is an alternative embodiment of an applicator with adjustable slot and flexible blade. FIG. 9 depicts an embodiment of an applicator for applying a top coating slurry comprising microfibrillated cellulose or comprising microfibrillated cellulose and one or more inorganic particulate material to forming web of paper below at the wet end of a paper machine, in which the angle and length of the flexible blade is adjustable in relation to the orientation of the applied slurry to a forming web of paper below at the wet end of a paper machine.

Generic applicator (60) has a channel (61) for introducing slurry (62). In FIG. 9, channel (61) comprises one or more bars (63) in channel (61) for causing turbulence of the slurry (62) along the path of channel (61). Channel (61) terminates at slot (64) shown in cross-sectional view. Slurry (62) exits slot (64) in substantially parallel orientation to the underside of flexible blade (65), thus guiding slurry (62) in a controlled angle in relation to the forming web of paper below (not shown).

Slot applicator (60) depicted in FIG. 9 further comprises fixed support (66) engaging movable support (67). Screw jack (68) attached to fixed support (66) permits controlling the height of slot (64). Profiling screw (69) is inserted through movable support (67) engaging the movable top lip member (70) of slot (64) Profiling screws (69) are evenly spaced across the width of the slot and enable localized control of the height of the channel to account for variations in flow across the width of the slot (not shown).

Also depicted in FIG. 9 is a blade holder (80) affixed by screw (81) to the movable lip member (70) shown in cross-sectional view. Blade holder (80) comprises a flexible blade (65) comprising metal tabs riveted to it across the width and these tabs slide into a slot (82) that is machined into rotating shaft (86). This allows for the blade to be aligned easily, changed during operation and keeps the blade in place regardless if the clamp tube is pressurized or not. The flexible blade with riveted tabs, is depicted in FIG. 11. FIG. 9 depicts an adjustable angle and adjustable blade length device. A rotation of 180 degrees on the shaft (86) can result in a 0-50 mm change in the blade length or more Blade holder (80) comprises inflatable tube (83) for operating clamp (84) engaging flexible blade (65) for controlling the angle of flexible blade (65) at a controlled angle relative to the forming web of paper below (not shown).

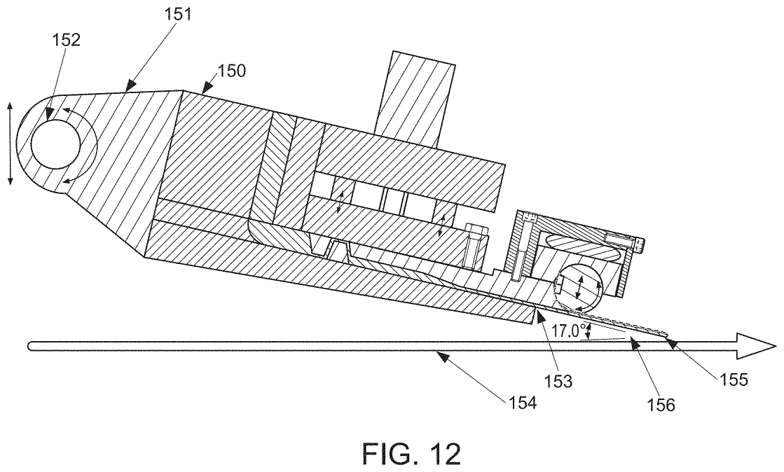

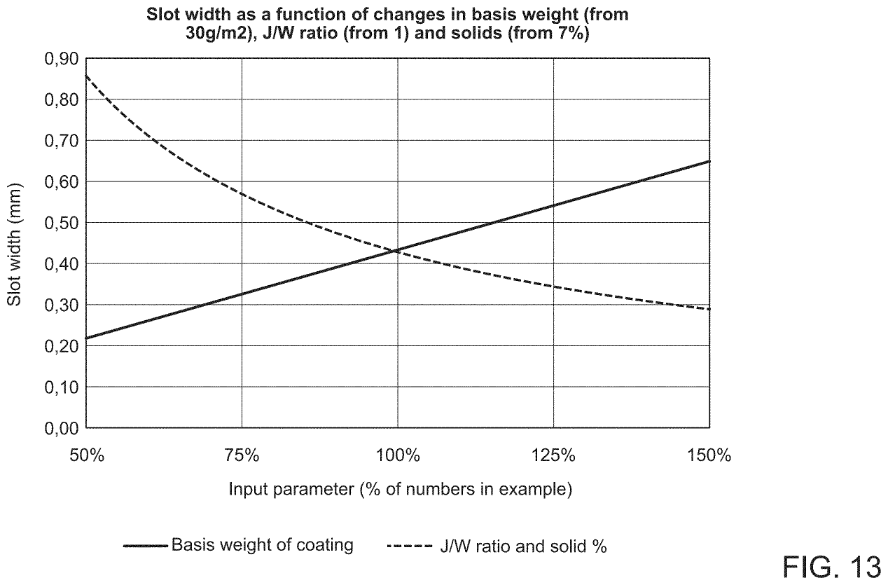

FIG. 12 is an alternative embodiment of an applicator with adjustable slot and flexible blade. FIG. 12 depicts slot applicator (150), which further comprises mounting brackets (151) evenly spaced along the width of the applicator. The mounting brackets (151) each have a pivot point (152) that are attached to a support beam (not shown) of sufficient size and capacity to span the width of the paper machine. The support beam, whether supported by hoist or mounted on posts with jacks at each side of the paper machine can raise or lower the applicator to adjust the opening of the slot (153) elevation in relation to the moving web (154). Rotating the applicator (150) along the pivot point (152) always for the slurry (155) jet angle (156) in relation to the moving web (154) to be varied.

The flexible blade of the present invention may be constructed in various sizes and with various materials. The distance from the slot of the applicator, as shown in FIGS. 7A and 7B, as well as FIGS. 8 and 9, correlates with the angle and length of the flexible blade and the velocity of the jet of slurry.

A typical length of the flexible blade is about 50 mm to 250 mm, with a range of about 50 mm to about 100 mm optimum.

Jet velocity is set in a ratio to the velocity of the forming web of paper. The optimum ratio is 1.0 with a target ratio of 0.7 to 1.6. In the comparative Example 1 below the ratio was 1.8.

Alternatively, an absolute speed difference between jet and web can be specified as a more physically significant parameter. In this case, the range would be −150 to +300 m/min, with the optimum around zero. Jet velocity is the calculated velocity out of the slot, not the actual velocity at the paper. This would be lower as the drag on the blade would slow down the velocity of the slurry.

The slurry is applied to the forming web of paper at 15-50 gsm, with an optimum of 30 gsm, for a typical white top liner paper or board.

In certain application, such as the application of a barrier coating comprising microfibrillated cellulose or comprising microfibrillated cellulose and one or more inorganic particulate material at a high percentage of pulp and lower inorganic particulate material content, the application rate of the slurry may only need to be about 1 gsm to about 15 gsm of microfibrillated cellulose. Thus, for certain applications such a producing a white top linerboard the microfibrillated cellulose content of the slurry can be in the range of 5 wt. % to about 30 wt. % of the total solids content and the one or more inorganic particulate material content may be in the range of 70 wt. % to 95 wt. %.

For barrier coatings the content of the one or more inorganic particulate material is 0 to 50 wt. %, with 0-10 wt. % being optimum.

The flowrate per width of the jet of slurry is controlled between 30 and 500 litres/min/m to cover the range from 15 gsm at 5% microfibrillated cellulose solids to 50 gsm at 1% microfibrillated cellulose solids for a 20% percentage of pulp slurry (POP) slurry

### Examples

The invention has been demonstrated using a laboratory ‘Helicoater’, which is a well-known device for simulating high speed coating at small scale. It consists of a rotating cylindrical drum, around which a paper substrate is wrapped, and a coating head aligned perpendicular to the axis of rotation of the drum, which can move laterally parallel to the rotation axis. To obtain a coating applied at a suitable speed, the drum is set into rotation at the desired rate, and then the coating head is brought into close proximity with the surface, flow of the coating formulation is initiated and the head moves rapidly along the axis of the drum, thus producing a helical coating on the paper around the drum, such that the velocity of the paper surface relative to the coating head (and perpendicular to its direction of travel) reaches a level similar to that found on commercial coaters.

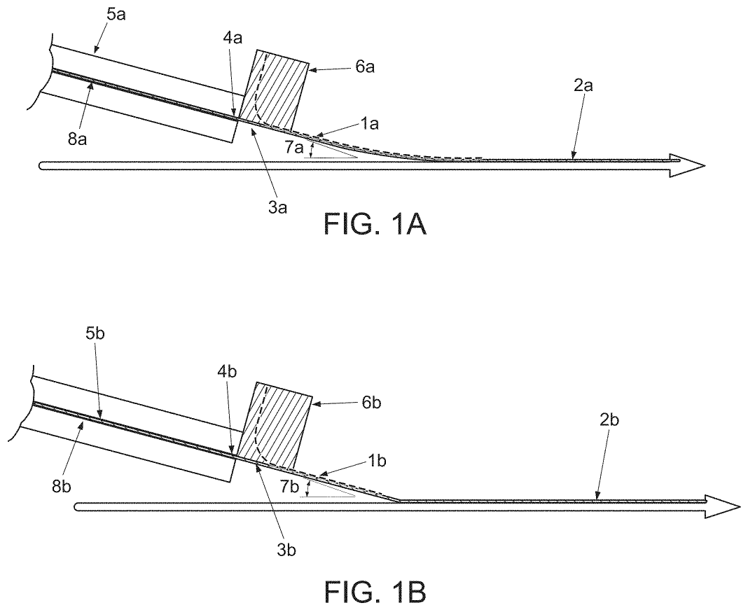

For the demonstration of the invention, a jet coating head was used, in which the coating formulation is forced under pressure through a narrow slot parallel with the forming web of paper and inclined at a small angle to it, in a similar configuration to the applicator shown in FIGS. 1A and 1B. A flexible plastic blade was attached to the head, so that the coating jet contacted the blade immediately upon exiting the slot. A series of blades of differing stiffness were tested to evaluate the effects of stiffness on the effectiveness of the invention. An absorbent base board of basis weight 300 gsm was used, in order to simulate the rapid dewatering of the MFC formulation after contact with the base sheet that would occur as the wet coated sheet passes over vacuum boxes on a paper machine. Coating formulations consisted of simple mixtures of 20% MFC and 80% of a filler grade precipitated calcium carbonate (Syncarb 240, Omya), suspended in water at a range of total solids contents between 5 and 12%. The coating formulation was pressurised in a reservoir, and at the start of the coating a valve connecting the reservoir to the coating head was opened, thus initiating the flow of formulation to the head. Suspension velocity at the exit of the slot was thus controlled by adjusting the pressure in the reservoir

### Example 1

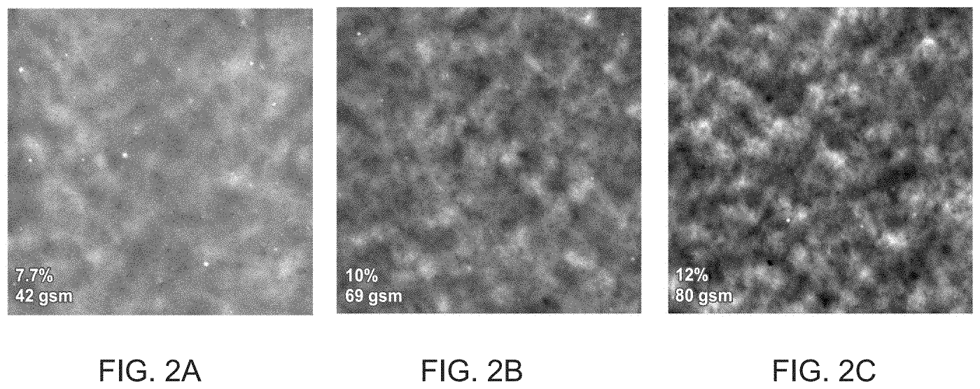

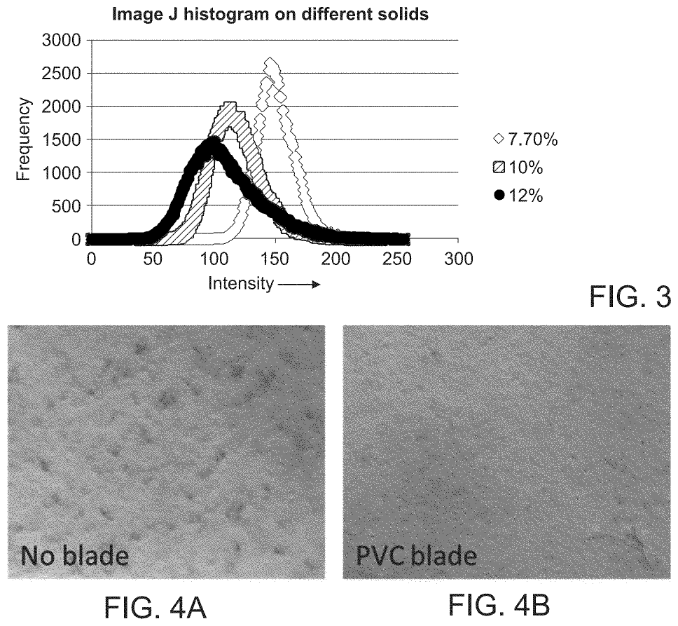

For this example, no flexible blade was used, and the effects of increasing solids on formation of the MFC/mineral coating layer were evaluated. In order to maintain the same jet velocity for all experiments, the same reservoir pressure was used for all formulations, with the result that the coat weight increased with solids concentration of the formulation. To minimize the effects of elongational break-up of the coating, rotation of the drum was set to a give a linear velocity of the paper surface at the coating head of 300 m/min, with a jet velocity of 540 m/min, thus a velocity ratio of 1.8. After drying, the coatings were peeled from the base papers, and formation was assessed visually and by mapping the variation in intensity of transmitted light in 2-dimensional flat-bed scans of the coated surfaces. Ordinarily, it would be expected that observed formation assessed in this way would improve with coat weight, as the opacity of the coating increases. However, as can be seen in FIG. 2 and FIG. 3, despite an almost doubling of coat weight, the formation of the coating made from a formulation at 12% solids was visibly worse than the coating from a formulation at 7.7% solids content. Quantitative analyses of the scans are shown in FIG. 3, where the number of pixels at each intensity is plotted against the light intensity on an arbritrary scale of 1 to 256, in which 256 represents total light transmission (no attenuation due to the coating) and 0 represents no light transmission, i.e. a completely opaque coating. The scans show a much wider range of intensities for the high solids formulation than the low, indicating more variation and thus poorer formation. Note that a perfectly uniform coating would give a narrow peak at a single intensity value using this analysis. The value of the intensity at the peak in each case correlates with the coat weight—because the coatings are viewed in transmission, the thicker the coating, the lower the intensity of transmission.

### Example 2

Two different blades were used according to the invention. Each bridged the gap between the coating head and the paper, and contacted the paper surface tangentially. Bending stiffness of the blades was measured using an L&W stiffness tester of the type used for measuring paper and board (AB Lorentzen & Wettre Paper Bending Tester used in accordance with DIN 53121, or another equivalent apparatus). Blade thicknesses and stiffness values are given in Table 1. For comparison, a coating was also applied without a blade present.

TABLE 1
Characteristics of the two blades used

| Blade material | Thickness/mm | Bending stiffness/mN m |
|---|---|---|
| Polycarbonate (PC) | 0.7 | 98 |
| Polyvinyl chloride (PVC) | 0.3 | 8 |

The drum rotation was set to achieve a velocity of 400 m/min at the coating head, and the same formulation as in Example 1, adjusted to 9.2% total solids, was applied at a velocity of 480 m/min, giving a jet/paper velocity ratio of 1.2. In each case, a coat weight of 45 gsm was applied. The stiff PC blade applied too much pressure to the coating, and scraped it off, leaving a very patchy and unacceptable result. In contrast, the PVC blade remained in light contact with the paper throughout the application of the coating, and did not reduce the coat weight or visibly remove any coating.

Error! Reference source not found. FIG. 4 shows photographs of the coatings, illustrating the difference in appearance between a coating applied at 9.2 wt. % total solids at a velocity of 480 m/min, giving a jet/paper velocity ratio of 1.2 and at a coat weight of 45 gsm with the PVC blade (FIG. 4B) and with none (FIG. 4A). There is a clear improvement with the blade. These coatings were not peeled from the basepaper after drying, because the formation of the coating applied without a blade at the solids content and coatweight used meant that it could not be removed without tearing. Therefore the coatings were scanned on the flatbed scanner using reflected light.

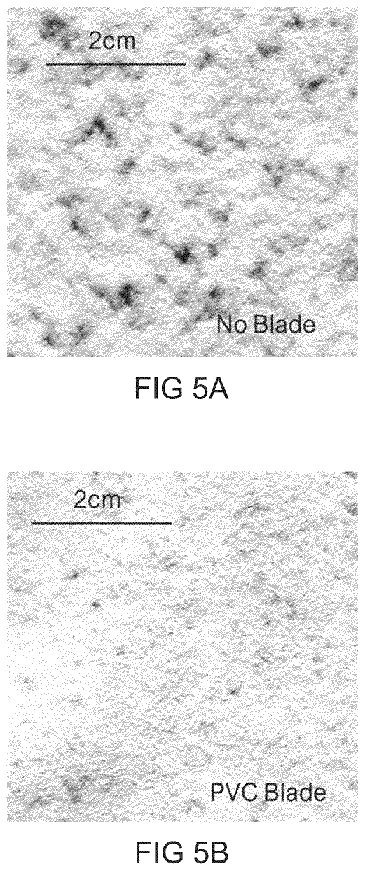

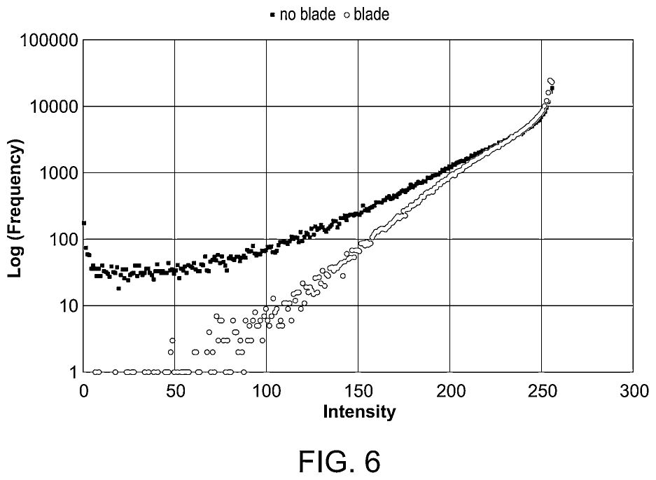

Magnified images from Flatbed scans in reflected light of the coated samples made with and without the blade are shown in FIG. 5B and FIG. 5B, respectively.

Those skilled in the art will recognize, or be able to ascertain using no more than routine experimentation, many equivalents to the specific embodiments of the invention described herein. The scope of the present invention is not intended to be limited to the above Description, but rather is as set forth in the following claims.

What is claimed is:

1. A method of making a paper or board product comprising a top ply comprising microfibrillated cellulose and, optionally, one or more inorganic particulate material, the method comprising: (a) providing a forming web of paper at the wet end of a paper machine; (b) providing a top ply slurry of microfibrillated cellulose of about 0.25 to about 5 wt. % of the total solids content of the slurry, and, optionally one or more inorganic particulate material, onto the forming web of paper through an applicator comprising a channel terminating in a slot, wherein the slot is in fluid communication with a flexible blade attached to the applicator so as to deliver the top ply at a controlled angle to the forming web of paper at the wet end of the paper machine; wherein the slurry remains substantially in contact with the flexible blade, wherein the slurry is delivered to the forming web of paper. wherein the forming web of paper and top ply are dewatered and pressed and a paper or board is recovered comprising said top ply.

2. The method according to claim 1, wherein the controlled angle is substantially parallel relative to the forming web of paper.

3. The method according to claim 1, wherein the controlled angle is about 10° to about 45° relative to the forming web of paper.

4. The method according to claim 1, wherein the controlled angle is about 15° to about 30° relative to the forming web of paper.

5. The method according to claim 1, wherein the controlled angle is about 20° to about 40° relative to the forming web of paper.

6. The method according to claim 1, wherein the controlled angle is about 10° relative to the forming web of paper.

7. The method according to claim 1, wherein the controlled angle is about 15° relative to the forming web of paper.

8. The method according to claim 1, wherein the controlled angle is about 20° relative to the forming web of paper.

9. The method according to claim 1, wherein the controlled angle is about 25° relative to the forming web of paper.

10. The method according to claim 1, wherein the controlled angle is about 30° relative to the forming web of paper.

11. The method according to claim 1, wherein the controlled angle is about 35° relative to the forming web of paper.

12. The method according to claim 1, wherein the controlled angle is about 40° relative to the forming web of paper.

13. The method according to claim 1, wherein the controlled angle is about 45° relative to the forming web of paper.

14. The method according to claim 1, wherein the flexible blade touches the forming web of paper.

15. The method according to claim 1, wherein the flexible blade does not touch the forming web of paper.

16. The method according to claim 1, comprising one or more inorganic particulate material.

17. The method according to any one of claims 1-16, wherein the slurry is provided at a flowrate of between about 30 and about 500 litres/min/m.

18. The method according to any one of claims 1-16, wherein the distance of the slot to the forming web of paper is about 50 mm to about 250 mm.

19. The method according to claim 17, wherein the distance of the slot to the forming web of paper is about 50 mm to about 250 mm.

20. The method according to any one of claims 1-16, wherein the velocity of the slurry to the velocity of forming web of paper is about −150 m/min to about +300 m/min.

21. The method according to claim 19, wherein the velocity of the slurry to the velocity of forming web of paper is about −150 m/min to about +300 m/min.

22. The method according to any one of claims 1-16, wherein the weighted average fibre length (Lc(w)) ISO is less than 0.7 mm.

23. The method according to claim 21, wherein the weighted average fibre length (Lc(w)) ISO is less than 0.7 mm.

24. The method according to claim 16, wherein the content of inorganic particulate material is from 0% to 50% by weight of the total solids content of the slurry.

25. The method according to claim 16, wherein the top ply comprises at least one inorganic particulate material selected from the consisting of the an alkaline earth metal carbonate or sulphate, calcium carbonate, magnesium carbonate, dolomite, gypsum, bentonite, montmorillonite, hydrous kandite clay, kaolin, halloysite or ball clay, an anhydrous (calcined) kandite clay, as metakaolin or fully calcined kaolin, talc, mica, perlite sepiolite, huntite, diatomite, magnesite, silicates, or diatomaceous earth, brucite, aluminum trihydrate, and combinations thereof.

26. The method according any one of claims 1-16, wherein the slurry is an aqueous composition.

27. The method according to any one of claims 1-16, wherein the slot has a vertical gap height of less than 2.5 mm.

28. The method according to claim 23, wherein the slot has a vertical gap height of less than 2.5 mm.

29. The method according any one of claims 1-16, wherein the velocity of the liquid composition at the point of impact with the forming web of paper is about the same as or higher than the speed of the forming web of paper.

30. The method according to claim 28, wherein the velocity of the liquid composition at the point of impact with the forming web of paper is about the same as or higher than the speed of the forming web of paper.

31. The method according any one of claims 1-16, wherein the flexible blade stiffness is between about 2 to about 75 mN m, as measured in accordance with DIN 53121.

32. The method according to claim 30, wherein the flexible blade stiffness is between about 2 to about 75 mN m, as measured in accordance with DIN 53121.

33. The method according to any one of claims 1-16, wherein the forming web of paper comprises greater than about 50 wt. % of water, based on the total weight of the forming web of paper.

34. The method according to claim 32, wherein the forming web of paper comprises greater than about 50 wt. % of water, based on the total weight of the forming web of paper.

35. The method according to any one of claims 1-16 wherein the forming web of paper comprises up to about 1 wt. % of retention aid, based on the total weight of the forming web of paper.

36. The method according to claim 34, wherein the forming web of paper comprises up to about 1 wt. % of retention aid, based on the total weight of the forming web of paper.

37. The method according to any one of claims 1-16, wherein the board product is a white top containerboard product.

38. The method according to claim 36, wherein the board product is a white top containerboard product.

39. The method according to any one of claims 1-16, wherein the paper or board has a grammage suitable for use in a containerboard product, comprising a grammage ranging from about 50 g/m² to about 500 g/m².

40. The method according to claim 36, wherein the paper or board has a grammage suitable for use in a containerboard product, comprising a grammage ranging from about 50 g/m² to about 500 g/m².

41. The method according to any one of claims 1-16, wherein the paper or board comprises recycled pulp, unbleached Kraft, or combinations thereof.

42. The method according to claim 40, wherein the paper or board comprises recycled pulp, unbleached Kraft, or combinations thereof.

43. The method according to any one of claims 1-16 wherein the inorganic particulate material and the microfibrillated cellulose comprise greater than 95 wt. % of the top ply, based on the total weight of the top ply.

44. The method according to claim 42, wherein the inorganic particulate material and the microfibrillated cellulose comprise greater than 95 wt. % of the top ply, based on the total weight of the top ply.

45. The method according to any one of claims 1-16, wherein the top ply comprises at least 70 wt. % of an inorganic particulate material, based on the total weight of the top ply.

46. The method according to claim 44, wherein the top ply comprises at least 70 wt. % of an inorganic particulate material, based on the total weight of the top ply.

47. The method according to any one of claims 1-16, wherein the top ply comprises at least about 80 wt. % of an inorganic particulate material, based on the total weight of the top ply.

48. The method according to claim 46, wherein the top ply comprises at least about 80 wt. % of an inorganic particulate material, based on the total weight of the top ply.

49. The method according any one of claims 1-16, wherein the inorganic particulate material comprises or is calcium carbonate.

50. The method according to claim 48, wherein the inorganic particulate material comprises or is calcium carbonate.

51. The method according to any one of claims 1-16, wherein the top ply comprises up to about 2 wt. %, in total, of additives selected from the group consisting of flocculant, formation/drainage aid, water soluble thickener, starch, retention aid, hydrophobic (sizing) agent, and combinations thereof.

52. The method according to claim 50, wherein the top ply comprises up to about 2 wt. %, in total, of additives selected from the group consisting of flocculant, formation/drainage aid, water soluble thickener, starch, retention aid, hydrophobic (sizing) agent, and combinations thereof.

53. The method according to any one of claims 1-16, wherein the top ply is devoid of additional organic compound.

54. The method according to claim 52, wherein the top ply is devoid of additional organic compound.

55. The method according to any one of claims 1-16, wherein the top ply is devoid of cationic polymer, anionic polymer, or polysaccharide hydrocolloid.

56. The method according to claim 54, wherein the top ply is devoid of cationic polymer, anionic polymer, or polysaccharide hydrocolloid.

57. The method according to any one of claims 1-16, wherein the top ply is an outer ply.

58. The method according to claim 56, wherein the top ply is an outer ply.

59. The method according to any one of claims 1-16, wherein the top ply is devoid of wax, polyolefins, and silicone.

60. The method according to claim 58, wherein the top ply is devoid of wax, polyolefins, and silicone.

61. The method according to claim 1, wherein the top ply consists essentially of inorganic particulate material and microfibrillated cellulose.

62. The method according to claim 16, wherein the top ply consists essentially of microfibrillated cellulose.

63. The method according to any one of claims 1-16, wherein the forming web of paper comprises a chemical pulp, or a chemi-thermomechanical pulp, or a mechanical pulp, unbleached Kraft pulp or a recycled pulp, or a papermill broke, or a papermill waste stream, or waste from a papermill, or a dissolving pulp, kenaf pulp, market pulp, partially carboxymethylated pulp, abaca pulp, hemlock pulp, birch pulp, grass pulp, bamboo pulp, palm pulp, peanut shell, or a combination thereof.

64. The method according to claim 60, wherein the forming web of paper comprises a chemical pulp, or a chemi-thermomechanical pulp, or a mechanical pulp, unbleached Kraft pulp or a recycled pulp, or a papermill broke, or a papermill waste stream, or waste from a papermill, or a dissolving pulp, kenaf pulp, market pulp, partially carboxymethylated pulp, abaca pulp, hemlock pulp, birch pulp, grass pulp, bamboo pulp, palm pulp, peanut shell, or a combination thereof.

65. The method according to any one of claims 1-16, wherein the forming web of paper is comprises an unbleached Kraft pulp, recycled pulp or a combination thereof.

66. The method according to any one of claims 1-16, wherein the microfibrillated cellulose is manufactured from a chemical pulp, or a chemi-thermomechanical pulp, or a mechanical pulp, unbleached Kraft pulp or a recycled pulp, or a papermill broke, or a papermill waste stream, or waste from a papermill, or a dissolving pulp, kenaf pulp, market pulp, partially carboxymethylated pulp, abaca pulp, hemlock pulp, birch pulp, grass pulp, bamboo pulp, palm pulp, peanut shell, or a combination thereof.

67. The method according to claim 60, wherein the microfibrillated cellulose is manufactured from a chemical pulp, or a chemi-thermomechanical pulp, or a mechanical pulp, unbleached Kraft pulp or a recycled pulp, or a papermill broke, or a papermill waste stream, or waste from a papermill, or a dissolving pulp, kenaf pulp, market pulp, partially carboxymethylated pulp, abaca pulp, hemlock pulp, birch pulp, grass pulp, bamboo pulp, palm pulp, peanut shell, or a combination thereof.

68. The method according to any one of claims 1-16, wherein the microfibrillated cellulose is manufactured from a unbleached Kraft pulp, recycled pulp, or combinations thereof.

69. The method according to claim 60, wherein the microfibrillated cellulose is manufactured from a unbleached Kraft pulp, recycled pulp, or combinations thereof.

70. An applicator for delivery of a top ply slurry of microfibrillated cellulose, and, optionally, one or more inorganic particulate material, to a forming web of paper at the wet end of a paper machine, comprising a fluid delivery channel terminating in a slot comprising an upper and lower surface, for applying the top ply slurry to the forming web of paper; a flexible blade attached to the upper surface of the slot, wherein said flexible blade guides delivery of the top ply slurry from the slot to the forming web of paper at the wet end of the papermaking machine at a controlled angle relative to the forming web of paper.

71. The applicator according to claim 70, wherein the controlled angle is substantially parallel to the forming web of paper.

72. The applicator according to claim 70, wherein the controlled angle is from about 10° to about 45° relative to the forming web of paper.

73. The applicator according to claim 70, wherein the controlled angle is from about 15° to about 30° relative to the forming web of paper.

74. The applicator according to claim 70, wherein the controlled angle is from about 20° to about 40° relative to the forming web of paper.

75. The applicator according to claim 70, wherein the controlled angle is about 10° relative to the forming web of paper.

76. The applicator according to claim 70, wherein the controlled angle is about 15° relative to the forming web of paper.

77. The applicator according to claim 70, wherein the controlled angle is about 20° relative to the forming web of paper.

78. The applicator according to claim 70, wherein the controlled angle is about 25° relative to the forming web of paper.

79. The applicator according to claim 70, wherein the controlled angle is about 30° relative to the forming web of paper.

80. The applicator according to claim 70, wherein the controlled angle is about 35° relative to the forming web of paper.

81. The applicator according to claim 70, wherein the controlled angle is about 40° relative to the forming web of paper.

82. The applicator according to claim 70, wherein the controlled angle is about 45° relative to the slot.

83. The method according to claim 70, wherein the flexible blade touches the forming web of paper.

84. The method according to claim 70, wherein the flexible blade does not touch the forming web of paper.

85. The applicator according to claim 70, wherein the delivery of the top ply slurry is at a flowrate of between about 30 and about 500 litres/min/m.

86. The applicator according to claim 70, wherein the top ply slurry remains substantially in contact with the flexible blade until the slurry contacts the forming web.

87. The applicator according to claim 70, wherein the distance of the slot to the forming web of paper is about 50 mm to about 250 mm.

88. The applicator according to any one of claims 83-85, wherein the distance of the slot to the forming web of paper is about 50 mm to about 250 mm

89. The applicator according to claim 70, wherein the velocity of the delivery of the top ply slurry to the velocity of forming web of paper is about −150 m/min to about +300 m/min.

90. The applicator according to claim 88, wherein the velocity of the delivery of the top ply slurry to the velocity of forming web of paper is about −150 m/min to about +300 m/min.

91. The applicator according to claim 70, wherein the flexible blade stiffness is between about 2 to about 75 mN m, as measured in accordance with DIN 53121.

92. The applicator according to claim 90, wherein the flexible blade stiffness is between about 2 to about 75 mN m, as measured in accordance with DIN 53121.

93. The applicator according to claim 70, wherein the slot has a vertical gap height of less than 2.5 mm.

94. The applicator according to claim 92, wherein the slot has a vertical gap height of less than 2.5 mm.

95. The applicator according to claim 70, wherein the fluid delivery channel remains unblocked by top ply slurry comprising fibers comprising a weighted average fibre length (Lc(w)) ISO is less than 0.7 mm.

96. The applicator according to claim 94, wherein the fluid delivery channel remains unblocked by top ply slurry comprising fibers comprising a weighted average fibre length (Lc(w)) ISO is less than 0.7 mm.3
